(19) United States
(12) Patent Application Publication
(10) Pub. No.: US 2026/0137086 A1
(43) Pub. Date: May 21, 2026

(54) METHODS TO REDUCE CONTAMINATION, BIOFILM AND FOULING FROM WATER SYSTEMS, SURFACES, AND PRODUCTS

(71) Applicant: Aequor Inc., Encinitas, CA (US)

(72) Inventor: Cynthia K. Burzell, Encinitas, CA (US)

(73) Assignee: Aequor Inc., Encinitas, CA (US)

(21) Appl. No.: 19/449,292

(22) Filed: Jan. 14, 2026

Related U.S. Application Data
(62) Division of application No. 17/597,270, now abandoned.
(60) Provisional application No. 62/870,287, filed on Jul. 3, 2019.

(51) Int. Cl. A01N 57/12; A01N 41/04; A01N 57/20; A01N 57/28; A01N 57/30; A01N 59/26; A01P 1/00

(52) U.S. Cl. CPC A01N 57/12; A01N 41/04; A01N 57/20; A01N 57/28; A01N 57/30; A01N 59/26; A01P 1/00

(57) ABSTRACT

The present disclosure describes compositions comprising one or more organophosphorous or organosulfuous compounds for treating contaminants in a liquid or a liquid composition, for killing, preventing, and/or inhibiting the growth of microorganisms on surfaces, and for increasing the biomass of yeast or algae in culture. The compositions are also useful for treating contaminants in yeast fermentation broth and for cleaning or protecting surfaces from the growth of microorganisms.

### CROSS REFERENCE TO RELATED APPLICATIONS

This application is a divisional application of U.S. patent application Ser. No. 17/597,210, filed Dec. 30, 2021, which is U.S. National stage application of PCT Patent Application No. PCT/US20/40739, filed Jul. 2, 2020, which claims the benefit of U.S. Provisional Patent Application 62/870,287, filed on Jul. 3, 2019, which are hereby incorporated by reference in their entirety.

### FIELD

This disclosure relates to organophosphorus and organosulfurous compounds and compositions thereof, and methods of using them in various applications.

### BACKGROUND

Microbial growth and fouling on surfaces and in water causes contamination, operational inefficiencies, and can result in human illnesses. Microbial contamination and/or fouling are problematic in processing industries such as agro-industry, food, water, healthcare, pharmaceutical, personal hygiene and beauty products. Contamination may consist of biological, chemical, or physical substances in contact with surfaces, water, as well, as in products, food, and plants.

Fouling may consist of both “microfouling” and “macrofouling.” Microfouling is the attachment of microorganisms such as bacteria, yeast, fungi, and microalgae on surfaces to form biofilm or to each other to form clumps. Microfouling causes corrosion, scale, slime, clogging, and clumping. Macrofouling is the attachment of foulers which are eukaryotes such as, barnacles, mussels and algae to surfaces. Macrofouling forms on the outside of underwater structures, pipelines, and ship hulls, and on the inside of ballast tanks, intake pipes used to carry water to cooling towers of all traditional and renewable energy plants, etc. Fouling results in operational inefficiencies and increased costs, including frequent replacement of degraded and fouled equipment, operational downtime and labor costs to apply treatments and remedies, and increased fuel consumption by over 50% (with the corresponding greenhouse gas emissions) to overcome clogging and hydrodynamic drag.

Another problem related to fouling occurs in fermentation facilities and algae ponds. The fermentation culture organisms such as, yeast, microalgae, and bacteria (including cyanobacteria) form clumps or foul on the surface of the water and wetted-surfaces. The clumping and fouling causes a decrease in oxygenation to the cell cultures and decreases biomass production and in turn decreases productivity (g/L/day) and yield. In addition, fermentation cultures get contaminated by bacteria that additionally compete with the fermentation culture for food sources. The contaminated fermentation cultures need to be cleaned and the contamination can cause the system to crash. Algae pond crashes account for an estimated 30% of current production on algae farms. In addition, the contamination can cause unwanted changes in flavor of the product.

The traditional remedies to remove microfouling and macrofouling are expensive and short term: physical removal (scraping, pressure washing, etc.), shock treatments of hazardous biocides, etc. Chemical remedies are additionally costly because they require HAZMAT protocols for shipping, storage, use, and disposal. Due to their toxic overload of ecosystems and organisms, many chemical remedies are being restricted or banned by regulators worldwide. For example, the Ports of Amsterdam and San Diego have banned copper from marine hull paint. Water authorities are limiting the level of chlorine permitted in water treatments. Regulators are banning endocrine disruptors and other biocides that bioaccumulate and harm plant and animal health—including that of humans. Thus, there is a need for novel treatment for microfouling and macrofouling.

Preservatives are natural or synthesized chemical compounds that maintain the integrity of a product's formulation, surface, or material by slowing or preventing microbial growth or undesirable chemical changes. For example, wood preservatives in treatments and/or coatings protect wood and lumber from mold, decay, pest infestation, decomposition from climate, surrounding conditions, etc. Preservatives in consumer and industrial products prevent contamination by mold, fungi, and bacteria, preservatives in food and beverages prevent decomposition, etc.

### SUMMARY

Provided herein are methods for treating or inhibiting contamination in water, on a surface, and/or in a product, the methods comprising administrating a composition in an effective amount comprising one or more of an organophosphorous compound, organosulfurous compound and/or antimicrobial, and/or sonication. This disclosure also relates to organophosphorus and organosulfurous compounds and methods of using the compounds and/or compositions for increasing the growth rate, biomass, yield, and productivity of algae and yeast. The present invention involves a novel solution for the problem presented above and is directed to a composition that effectively cleans, treats contamination, or boosts biomass or algae and yeast. Thus, someone skilled in the art, using the compositions of the present invention can avoid problems associated with biofilm and fouling.

The compounds and/or compositions described herein include one or more organophosphorous or organosulfurous compounds, one or more derivatives thereof, one or more salts or solvates thereof, or one or more solvates of the salts thereof. In embodiments, the one or more organophosphorous or organosulfurous compounds have Formula I, II, or III described below. The compositions described herein further include one or more of antimicrobial agents, antibiofilm agents, surfactants, antifoaming agents, preservatives, agents providing scent, solvents, or a combination of one or more thereof.

In embodiments, the composition acts as a cleaning agent, dispersant, surfactant, and/or biofilm removal and/or prevention agent, anti-biofilm, antifouling, antimicrobial, antifungal, and/or agent against other organisms.

In embodiments, the composition is a formulation to be added to a solution, including water, ink, or the like. The composition can be formulated on a wetted surface, including in a coating, paint, chemically bound material, or the like. The composition can also be formulated with nanotechnology. In embodiments, the composition is formulated with controlled-release technology. The composition is comprised in polymeric material. The antimicrobial composition is comprised in polymeric material and/or in substitutes for polymeric material, such as polymers produced from algae. The composition is comprised in water filters, including activated carbon filters, reverse osmosis, UV filters, or the like.

In embodiments, the composition is in an automatic or manually operated dispenser. In embodiments, the dispenser dispenses the composition on a surface or in water. In embodiments, the dispenser is for a handrail for a moving walkway or escalator.

In embodiments, the contamination includes one or more bacteria, including waterborne bacteria, such as Campylobacter jejuni, Escherichia coli, Giardia lambia, Hepatitis A, Legionaella pneumophila, Salmonella enterica, and others, as well as Staphylococcus aureus, Staphylococcus epidermidis, Acinetobacter baumannii, Pseudomonas aeruginosa, Enterobacteriaceae, Salmonella bongori, Enterococcus faecium, Helicobacter pylori, Campylobacter spp., Neisseria gonorrhoeae, Streptococcus pneumoniae, Streptococcus mutans, Streptococcus gordonii, Streptococcus pyogenes, Haemophilus influenzae, Shigella spp., Klebsiella pneumoniae, Clostridium difficile, Bacillus anthracis, Yersinia pestis, Francisella tularensis, Burkholderia mallei, Burkholderia pseudomallei, Corynebacterium spp., Micrococcus luteus, Micrococcus lylae, Micrococcus roseus, Cutibaceterium acnes, Vibrio vulnificus, Vibrio cholerae, Vibrio parahaemolyticus, Propionibacterium acnes, Neisseria gonorrhoeae, Burkholderia cepacia, Burkholderia mallei, Burkholderia pseudomallei, Ralstonia pickettii, Cuprividus metalliduran, and/or biofilm-forming bacteria found on aquatic surfaces, including Cobetia marina and others.

In embodiments, the eukaryotic fouling contamination are caused by algae and microalgae, including Euglenophyta, Chrysophyta, Pyrrophyta, Chlorophyta, Rhodophyta, Paeophyta, and/or Xanthophyta, macroalgae, seaweed, blue green algae, plants, including sea grasses; and animals, including tunicates, mussels, oysters, clams, barnacles, cnidarians, sponges, and larvae. In embodiments, the fungal contamination is caused by fungi, including Zygomycota, Ascomycota, Basidiomycota, Deuteromycota, and others, and/or other eukaryotic foulers.

In embodiments, the organophosphorous or organosulfurous compounds are sodium dodecylbenzenesulfonate (SDBS), sodium dodecyl sulfate (SDS), 4-Dodecylbenzenesulfonic acid (DBSA), butyl phosphoramidate (BPA), (4-aminophenetyl) dimethylphosphine oxide (APDMPO), dibutyl phosphate (DBP), and/or dibutyl phosphite (DBPT).

In embodiments, the organophosphorous and/or organosulfurous compounds are present in the composition at a concentration of between 0.00001% to 5.0%.

In embodiments, the antimicrobial agent may be oxidizing (halogenated, non-halogenated, and acid) biocides, metals (ionic or salts), and/or non-oxidizing biocides, ozonated water, acids, naturally occurring biocides such as chitosan, and/or plant derived compounds. In embodiments the biocides include but are not limited to, chlorine (free chlorine, hypochlorous acid, hypochlorite salts), chlorine dioxide, sodium chloride, bromine, iodine, hydrogen peroxide, chlorhexidine, bismuth thiols (e.g., bismuth ethanedithiol), potassium permanganate, peracetic acid, propionic salts, parabens, 2-(Decylthio) ethanamine (DTEA), glutaraldehyde, ortho-phthalaldehyde, tetrakish (hydroxymethyl) phosphonium sulfate (THPS), tributyltetradecylphosphonium chloride (TTPC), 2-Bromo-4-hydroxyacetopne (BHAP), 2-Bromo-2-nitropropane-1,3-diol (Bronopol), sodium dimethyldithiocarbamate (DIBAM), disodium ethylene bisdithiocarbamate (NIBAM), potassium n-hydroxymethyl-n-methyldithiocarbamate, 2,2 Dihydroxy-5,5-dichlorodiphenyl monosulfide (Chlorothioether), 2-2-Dibromo-3-nitrilopropionamide (DBNPA), methylene bis(thiocyanate) (MBT), polyquats (e.g., poly [oxyethylene (dimethyliminio) ethylene, dichloride]), quaternary ammonium compound (Quats) (e.g., alkyldimethylbenzylammonium chloride, ADBACs), sulfone (e.g., Bis(trichloromethyl) sulfone), bis(tributyltin) oxide (TBTO), 2-(tert-butylamino)-4-chloro-6-(ethylamino)-s-triazine (TBZ), tetrachloro-2,4,6-cyano-3-benzonitrile (TCCBN), 2 (thiocyanomethylthio) benzothiazole (TCMTB), tetrahydro-3,5,dimethyl-2H-1,3,5-thiadiazine-2-thione, isothiazolines including chloromethylisothiazolinone (CMIT), methylisothiazolinone (MIT), and 1,2-benzisothiazolin-3-one (BIT), guanides, including, guanidine and biguanides (e.g., dodecylguanidine hydrochloride and acetate, polyhexamethylene biguanide hydrochloride, and/or tetradecylguanidine. In embodiments, the concentration of biocide is a concentration of between 0.01% to 5%. In embodiments, the concentration of chlorine is a concentration of between 0.1 ppm to 50 ppm. In embodiments, the metals include but are not limited to, silver, copper, aluminum, gold, zinc, bronze, brass, and tin and their derivatives. In embodiments, the silver compound is silver ions, silver particles, silver nanoparticles, metallic silver, colloidal silver, silver sulfate, or silver chloride. In embodiments, concentration of the silver is a concentration of between 0.01 ppm to 30 ppm. In embodiments, the zinc compound includes, zinc acetate, zinc octoate, zinc pyrithione, zinc sulfate, and/or zinc oxide. In embodiments, concentration of the zinc is a concentration of between 0.01 to 5%. In embodiments, the concentration of chitosan is a concentration of between 0.01 to 5%. In embodiments, the concentration of acid is a concentration of between 0.01% to 5%. In embodiments, the plant derived compound includes orange essential oil, lemon essential oil, oregano essential oil, thyme essential oil, cinnamon essential oil, citral, cinnamaldehyde, carvacrol, thymol, citric acid, itaconic acid, aconitic acid, isocitric acid, succinic acid, fumaric acid, malic acid, glyoxylic acid, pyruvic acid, 2-oxoglutaric acid, 2-phosphoenolpyruvic acid, phosphoenolpyruvate carboxylase, and/or aloe. In embodiments, concentration of plant derived compound is a concentration of between 0.01 to 5%. In embodiments, the acid is maleic acid, clavulanic acid, glucaric acid, formic acid, carboxylic acid, hypochlorous acid, and/or hydrochloric acid. In embodiments, concentration of acid is a concentration of between 0.001 to 5%.

In embodiments, the organophosphorous or organosulfurous compounds and/or antimicrobials are used with sonication. In embodiments, the compounds are used with a sonicating brush. In embodiments, the compounds are used after a surface is treated with sonication. In embodiments, the ultrasonic frequency is 20 kHz to 40 KHz.

Further provided herein is a method of preventing and/or removing microorganisms on or surface, such as an industrial or household surface, the method comprising contacting a surface with a composition in an effective amount comprising one or more of an organophosphorous compound, organosulfurous compound, and antimicrobial.

In embodiments, the composition is a cleaning agent, dispersant, surfactant, wetting agent, wet edge enhancer, emulsifier, compatibilizer; and/or anti-odor agent, freshener, agent to disrupt, remove, prevent and/or inhibit biofilm; agent to disrupt, remove, prevent and/or remove fouling; agent to disrupt, remove, prevent, and/or inhibit microbial growth and kill microorganisms, including bacteria, fungi, viruses, and other microorganisms.

In embodiments, the compound and/or composition is used during the fermentation of algae, yeast, fungi, and bacteria. The compound and/or composition can act to increase the growth rate, biomass, yield, and productivity of fermentation. The compound and/or composition can be used to reduce biofilm formation, fouling and/or clumping. The compound and/or composition can be used to clean or reducing contamination of the fermentation cultures, water, surfaces, equipment, or containers. The compound and/or composition can be used to before, during, and/or after the fermentation process. The compound and/or composition can be used as a coating on fermentation system surfaces and equipment. The compound and/or composition can be used as an additional carbon source for the fermentation organisms. The compound and/or composition can be used as a dispersant. The compound and/or composition can be used as an additive to the growth media as a salt, acid, and/or pH adjuster. In embodiments, the species of algae include but are not limited to, Chlamydomonas spp., Chlorella spp., Haematococcus spp., and Dunaliella spp. In embodiments, the species of yeast include but are not limited to, Saccharomyces cerevisiae, Pichia pastoris and Candida albicans. In embodiments, the species of fungi include but are not limited to, Aspergillus spp., Trichoderma spp. In embodiments, the species of bacteria and filamentous bacteria include but are not limited to, Lactobacillus spp., Bifidobacterium spp., Bacillus spp., E. coli, Streptomyces spp., Actinoplanes spp. In embodiments, the fermentation contaminants are bacterial (e.g., Lactobacillus fermentum and L. delbruecki) and rotifers. In embodiments, concentration of the organophosphorous, organosulfurous compound is a concentration of between 0.0001% to 5%.

In embodiments, the composition consists of an antifoam agent. In embodiments, the antifoam agent is silicone based, non-silicone based, and contain polyether dispersions. In embodiments, the antifoam agent includes but are not limited to, SE-15, SAG 710, Silwet DA-33, SagTex DSA. SE-15 contains 10% active silicon and non-ionic emulsifiers. In embodiments, concentration of the antifoam agent is a concentration of between 0.001% to 1%.

In embodiments, the disclosure provides a method of the use of organophosphorous or organosulfurous compounds in combination with natural and/or synthesized water-borne, oil-borne, or light organic solvent chemical preservatives to increase the durability and resistance of wood, timber, wood structures, or engineered lumber from being destroyed by insects, fungi, other microorganisms, and/or climate and surrounding elements, etc. Application processes include pressure processes, non-pressure processes, such as spraying, soaking, dipping, bathing, brush and spray treatments, steeping, and other processes and treatments.

In embodiments, the disclosure provides a method to prevent soil, microfouling, and contamination when embedded in or coated on natural or synthetic rubber, plastic, silicone, metal, glass, or other surfaces. In embodiments, the agent is incorporated in Oomoo 25 and Oomoo 30 silicone rubber compound (Smooth-On) and Smooth-Cast liquid plastic compound (Smooth-On) per manufacturer's instructions. In embodiments, the coating is for pipes for a water system. In embodiments, the composition is for a washing machine, dishwater, refrigerator. In embodiments, the composition is for the rubber backing on a bath mat, and other flooring materials.

In embodiments, the disclosure provides a method to clean, decontaminate, and descale equipment, appliances and parts, and/or devices including but not limited to washing machines, refrigerators, dishwashers, coffee makers, water purifiers and other industrial, commercial and household appliances. In embodiments, the agent cleans and descales water systems, including those used in a refrigerator, coffee maker, water purifier, water dispenser, fountain, greenhouse, pool, aquaculture, and/or irrigation systems.

### BRIEF DESCRIPTION OF THE DRAWINGS

FIGS. 1A, 1B, and 1C. Antibiofilm activity of A1026 against mixed species biofilm B. cepacia, R. pickettii, and C. metallidurans. Control biofilm growth shows thick biofilm (A). A1026 at 0.0038% (v/v) shows loosely associated cells and no biofilm (B). A1026 at 0.007% (v/v) shows loosely associated dead cells and no biofilm (B). Live cells in the biofilm are stained green with SYTO 9 green fluorescent nucleic acid stain and dead cells are stained red with the red-fluorescent nucleic acid stain, propidium iodide. Scale bar is 1000 μm.

FIG. 2. Water Processor Assembly (WPA) schematic.

FIG. 3. Biomass boosting activity of compound for yeast after 140 hours of growth.

FIG. 4. Biomass boosting activity of compound for algae after 15 days of growth.

### DETAILED DESCRIPTION

This disclosure relates to organophosphorous and organosulfurous compounds and their use in the prevention or treatment of microbial contamination and fouling. The disclosure also relates to combination therapy using a composition comprising organophosphorous compounds, organosulfurous compounds and/or antimicrobial, and/or sonication in methods for treating or inhibiting microbial contamination and fouling in water, on wetted surfaces, and consumer and industrial surfaces. This disclosure also related to organophosphorus and organosulfurous compounds and methods of using the compounds to increase the growth rate, biomass, yield, and/or productivity of algae and yeast.

All publications and patent applications herein are incorporated by reference to the same extent as if each individual publication or patent application was specifically and individually indicated to be incorporated by reference.

As used herein, the term “or” is understood to be inclusive unless specifically stated or obvious from context to the contrary. As used herein, the terms “a”, “an”, and “the” are understood to be singular or plural unless specifically stated or obvious from context to the contrary.

Furthermore, “and/or” where used herein is to be taken as specific disclosure of each of the two or more specified features or components with or without the other. Thus, the term “and/or” as used in a phrase such as “A and/or B” herein is intended to include “A and B,” “A or B,” “A” (alone), and “B” (alone). Likewise, the term “and/or” as used in a phrase such as “A, B, and/or C” is intended to encompass each of the following embodiments: A, B, and C; A, B, or C; A or C; A or B; B or C; A and C; A and B; B and C; and A (alone); B (alone); and C (alone).

Unless otherwise indicated, as used herein, the recitation of “%” in reference to concentration indicates that the concentration of the molecule in the composition as “% w/w,” or “% v/v,” and that the concentration is relative to the total weight or total volume of the composition, respectively. As an example, for a formulation where the components are dry and the concentrations are determined by weight, the concentration of the molecule would be “% w/w,” and for a formulation where the components are aqueous and the concentrations are determined by volume, the concentration of the molecule would be “% v/v.”

In embodiments, provided herein are methods for treating or inhibiting bacterial, fungal, or fouling contamination in water, on wetted surfaces, and consumer and industrial surfaces, the method comprising administrating a composition in an effective amount comprising one or more of an organophosphorous compound, organosulfurous compound, and an antimicrobial, and sonication.

The compositions described herein include one or more organophosphorous or organosulfurous compounds, one or more derivatives thereof, one or more salts or solvates thereof, or one or more solvates of the salts thereof. In embodiments, the one or more organophosphorous or organosulfurous compounds have Formula I, II, or III described below. The compositions described herein further include one or more of antimicrobial agents, surfactants, antifoaming agents, preservatives, agents providing scent, solvents, or a combination of one or more thereof.

In embodiments, the organophosphorus compound, is represented by Formula I:

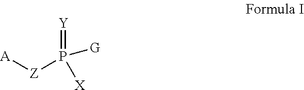

or a salt thereof; wherein A is H, C₁₋₁₆ hydrocarbyl or optionally R¹ substituted C₁₋₁₆ hydrocarbyl; Z is O or a bond; Y is O; G is OH, H, C₁₋₆—COO-alkyl, —O—C₁₋₁₆ alkyl, R¹ substituted C₁₋₁₀ hydrocarbyl, CH₂NHCH₂COOH, or O-aryl; X is H, CN, —NHR, —NHOR, —NHOCOR, R¹ substituted C₁₋₁₀ hydrocarbyl or —OR; and R is H, C₁₋₁₀ hydrocarbyl, or optionally R¹ substituted C₁₋₁₀ hydrocarbyl;
R¹ is selected from halogen, cyano, OH, C₁₋₆ hydrocarbyl, C₁₋₆ alkoxy, SOR², SO₂R², SO₂NR³R⁴, CONR³R⁴, NR³R⁴, NR³COR⁴, NR³SO₂R⁴, NR³CO₂R⁴, NR³CONR⁴, and phosphonic acid, wherein each of C₁₋₆ hydrocarbyl, C₁₋₆ alkoxy, SOR², SO₂R², SO₂NR³R⁴, CONR³R⁴, NR³R⁴, NR³COR⁴, NR³SO₂R⁴, NR³CO₂R⁴, NR³CONR⁴, can be optionally substituted with halo, amino, hydroxyl, C₁₋₆ hydrocarbyl, C₁₋₆ alkoxy, cyano, or phosphonic acid; and
R², R³ and R⁴ are independently selected from hydrogen, C₁₋₆ hydrocarbyl, in which each of the C₁₋₆ hydrocarbyl can be optionally substituted with halo, amino, hydroxyl, C₁₋₆ alkoxy, cyano, or phosphonic acid.

In embodiments, the organophosphorus compound, is represented by Formula II:

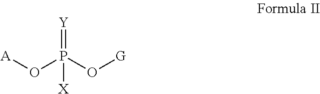

where A is R, Y is O or S, X is NH2, OH, or OR, and G is R, where R is C₁₋₁₆ hydrocarbyl;
R¹ is selected from halogen, cyano, OH, C₁₋₆ hydrocarbyl, C₁₋₆ alkoxy, SOR², SO₂R², SO₂NR³R⁴, CONR³R⁴, NR³R⁴, NR³COR⁴, NR³SO₂R⁴, NR³CO₂R⁴, NR³CONR⁴, and phosphonic acid, wherein each of C₁₋₆ hydrocarbyl, C₁₋₆ alkoxy, SOR², SO₂R², SO₂NR³R⁴, CONR³R⁴, NR³R⁴, NR³COR⁴, NR³SO₂R⁴, NR³CO₂R⁴, NR³CONR⁴, can be optionally substituted with halo, amino, hydroxyl, C₁₋₆ hydrocarbyl, C₁₋₆ alkoxy, cyano, or phosphonic acid; and
R², R³ and R⁴ are independently selected from hydrogen, C₁₋₆ hydrocarbyl, in which each of the C₁₋₆ hydrocarbyl can be optionally substituted with halo, amino, hydroxyl, C₁₋₆ alkoxy, cyano, or phosphonic acid.

In embodiments, the organosulfurous compound, is represented by Formula III:

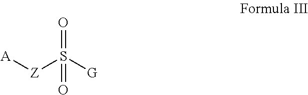

or a salt thereof; wherein A is H, C₁₋₂₀ hydrocarbyl, alkylaryl, or optionally R¹ substituted C₁₋₂₀ hydrocarbyl; Z is O or a bond; G is OH, H, C₁₋₆—COO-alkyl, —O—C₁₋₆ alkyl, R¹ substituted C₁₋₁₀ hydrocarbyl, CH₂NHCH₂COOH, or O-aryl;
R¹ is selected from halogen, cyano, OH, C₁₋₆ hydrocarbyl, C₁₋₆ alkoxy, SOR², SO₂R², SONR³R⁴, CONR³R⁴, NR³R⁴, NR³COR4, NR³SOR⁴, NR³COR⁴, NR³CONR⁴, and phosphonic acid, wherein each of C₁₋₆ hydrocarbyl, C₁₋₆ alkoxy, SOR², SO₂R², SO₂NR³R⁴, CONR³R⁴, NR³R⁴, NR³COR⁴, NR³SO₂R⁴, NR³CO₂R⁴, NR³CONR⁴, can be optionally substituted with halo, amino, hydroxyl, C₁₋₆ hydrocarbyl, C₁₋₆ alkoxy, cyano, or phosphonic acid; and
R², R³ and R⁴ are independently selected from hydrogen, C₁₋₆ hydrocarbyl, in which each of the C₁₋₆ hydrocarbyl can be optionally substituted with halo, amino, hydroxyl, C₁₋₆ alkoxy, cyano, or phosphonic acid.

With respect to any relevant structural representation, such as Formula I or Formula III, Z is O or a bond. In embodiments, Z is O. In embodiments, Z is a bond.

With respect to any relevant structural representation, such as Formula I, Y is O.

With respect to any relevant structural representation, such as Formula I, Formula II or Formula III, G is OH, —O-alkyl (such as —OCH₃, —OC₂H₅, —OC₃H₇, —OC₄H₉, —OC₅H₁₁, —OC₆H₁₃, etc.), C₁₋₆—COO-alkyl, R¹ substituted C₁₋₁₀ hydrocarbyl, or O-aryl. In embodiments, G is —OCH₃. In embodiments, G is —OC₂H₅. In embodiments, G is —OC₄H₉. In embodiments, G is CH₂COOCH₃. In embodiments, G is OCH₂CF₃. In embodiments, G is C₂H₄CHNH₂COOH. In embodiments, G is O-phenyl. In embodiments, G is CH₂NHCH₂COOH. In embodiments, G is O Na.

With respect to any relevant structural representation, such as Formula I, X is H, CN, —NHR, —NHOR, —NHOCOR, R¹ substituted C₁₋₁₀ hydrocarbyl or —OR; and R is H, C₁₋₁₀ hydrocarbyl, or optionally R¹ substituted C₁₋₁₀ hydrocarbyl. In embodiments, X is H. In embodiments, X is OR. In embodiments, X is OH. In embodiments, X is OCH₃. In embodiments, X is —OC₂H₅. In embodiments, X is —NHR. In embodiments, X is —NH₂. In embodiments, X is OCH₂CF₃. In embodiments X is CN.

With respect to any relevant structural representation, such as Formula I, R is H or C₁₋₁₀ hydrocarbyl, including C₁₋₁₀ alkyl (e.g. methyl; C₂ alkyl, such as ethyl; C₃ alkyl, such as propyl, isopropyl, cyclopropyl, etc.; C₄ alkyl, such as linear, branched or cyclic, butyl, etc.; C₅ alkyl, C₆ alkyl, C₇ alkyl, C alkyl, C₉ alkyl, or C₁₀ alkyl), C₁₋₆ alkyl, C₁₋₃ alkyl, C₁₋₁₀ alkenyl (e.g. C₂ alkenyl, such as vinyl; C₃ alkenyl, such as —CH₂—CH═CH₂,C₄ alkenyl, such as linear, branched or cyclic, butenyl, etc.; C₅ alkenyl, C₆ alkenyl, C₇ alkenyl, C alkenyl, C₉ alkenyl, or C₁₀ alkenyl), C₂₋₆ alkenyl, C₂₋₄ alkenyl, optionally substituted aryl, such as phenyl or hydrocarbyl substituted phenyl, naphthyl, etc. In embodiments, R is H. In embodiments, R is C₁₋₆ alkyl. In embodiments, R is C₁₋₃ alkyl. In embodiments, R is CH₃. In embodiments, R is C₂H₅. In embodiments, R is CH₂CF₃.

With respect to any relevant structural representation, such as Formula I Formula II, or Formula III, A is H, C₁₋₂₀ hydrocarbyl, including C₁₋₁₂ alkyl (e.g. methyl; C₂ alkyl, such as ethyl; C₃ alkyl, such as propyl, isopropyl, cyclopropyl, etc.; C₄ alkyl, such as linear, branched or cyclic, butyl, etc.; C₅ alkyl, C₆ alkyl, C₇ alkyl, C alkyl, C₉ alkyl, C₁₀ alkyl, C₁₁ alkyl or C₁₂ alkyl), C₁₋₆ alkyl, C₁₋₃ alkyl, C₁₋₁₀ alkenyl (e.g. C₂ alkenyl, such as vinyl; C₃ alkenyl, such as —CH₂—CH═CH₂,C₄ alkenyl, such as linear, branched or cyclic, butenyl, etc.; C₅ alkenyl (such as isopentenyl), C₆ alkenyl, C₇ alkenyl, C alkenyl, C₉ alkenyl, or C₁₀ alkenyl), C₂₋₆ alkenyl, C₂₋₄ alkenyl, aryl, such as phenyl or napthyl, alkylaryl, or optionally R¹ substituted C₁₋₂₀ hydrocarbyl.

With respect to any relevant structural representation, such as Formula I, Formula II, or Formula III, R¹ is selected from halogen, cyano, OH, C₁₋₆ hydrocarbyl, C₁₋₆ alkoxy, SOR², SO₂R², SO₂NR³R⁴, CONR³R⁴, NR³R⁴, NR³COR⁴, NR³SO₂R⁴, NR³CO₂R⁴, NR³CONR⁴, and phosphonic acid, wherein each of C₁₋₆ hydrocarbyl, C₁₋₆ alkoxy, SOR², SO₂R², SO₂NR³R⁴, CONR³R⁴, NR³R⁴, NR³COR⁴, NR³SO₂R⁴, NR³CO₂R⁴, NR³CONR⁴, can be optionally substituted with halo, amino, hydroxyl, C₁₋₆ hydrocarbyl, C₁₋₆ alkoxy, cyano, or phosphonic acid.

With respect to any relevant structural representation, such as Formula I, Formula II, or Formula III, R², R³ and R⁴ are independently selected from hydrogen, C₁₋₆ hydrocarbyl, in which each of the C₁₋₆ hydrocarbyl can be optionally substituted with halo, amino, hydroxyl, C₁₋₆ alkoxy, cyano, or phosphonic acid.

With respect to any relevant structural representation, such as Formula I, Formula II, or Formula III, in embodiments, A is H. In embodiments, A is C₁₋₆ alkyl. In embodiments, A is ethyl. In embodiments, A is C₃ alkyl, such as n-propyl, isopropyl, or cyclopropyl. In embodiments, A is n-propyl. In embodiments, A is isopropyl. In embodiments, A is C₄ alkyl, such as n-butyl, t-butyl, or cyclobutyl. In embodiments, A is n-butyl. In embodiments, A is t-butyl. In embodiments, A is C₅ alky, such as n-pentyl, isopentyl, cyclopentyl, etc. In embodiments, A is n-pentyl. In embodiments, A is isopentyl. In embodiments, A is C₆ alkyl, such as n-hexyl, cyclohexyl, etc. In embodiments, A is n-hexyl. In embodiments, A is C₃₋₅ alkenyl, such as propenyl, butenyl, isopentenyl, pentenyl, etc. In embodiments, A is C₅ alkenyl. In embodiments, A is isopentenyl. In embodiments, A is alkylaryl.

With respect to any relevant structural representation, such as Formula I, Formula II, or Formula III, in embodiments, A is —(CH₂)₁₋₂-Cy, wherein Cy is optionally substituted cycloalkyl (such as cyclopropyl, cyclobutyl, cyclopentyl, cyclohexyl) or optionally substituted phenyl. In embodiments, A is

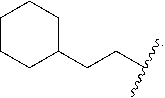 [SMILES: *CCC1CCCCC1]

In embodiments, A is

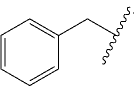 [SMILES: *Cc1ccccc1]

In embodiments, A is R¹ substituted alkyl. In embodiments, A is CF₃. In embodiments, A is C₂H₄OH. In embodiments, A is 1-amino-1-phenyl methyl. In embodiments, A is 1-amino-2-phenyl-ethyl.

In embodiments of Formula I, Y is O, Z is O, A is C₄H₉, G is OC₄H₉, and X is selected from the group consisting of H, OH, OCH₃, and NH₂. In embodiments, X is H. In embodiments, X is OH. In embodiments, X is OCH₃. In embodiments, X is NH₂.

In embodiments of Formula I, Y is O, Z is O, A is CH₂CF₃, G is CH₂OOOCH₃, and X is OCH₂CF₃. In embodiments, Y is O, Z is O, A is CH₂CF₃, G is OCH₂CF₃, and X is H. In embodiments, Y is O, Z is O, A is C₂H₅, G is OC₂H₅, and X is CF₂Br. In embodiments, Y is O, Z is O, A is C₂H₅, G is OC₂H₅, and X is CN.

In embodiments of Formula I, Y is O, Z is a bond, A is C₂H₄OH, G is OCH₃, and X is OCH₃.

In embodiments, the compounds included in the compositions described herein comprise the organophosphorous or organosulfurous compounds, derivatives thereof, salts thereof (including salts of the derivatives), and solvates thereof (including solvates of the salts and derivatives). In embodiments, the compositions described herein include a combination of the organophosphorous and/or organosulfurous compounds, derivatives, salts, or solvates described herein. Suitable salts of the compounds disclosed herein can be prepared from an inorganic acid or an organic acid. Examples of such inorganic acids include hydrochloric, hydrobromic, hydroiodic, nitric, carbonic, sulfuric and phosphoric acid. Appropriate organic acids can be selected from aliphatic, cycloaliphatic, aromatic, arylaliphatic, heterocyclic, carboxylic and sulfonic classes of organic acids.

Suitable salts of the compounds disclosed herein can be prepared from a metallic salt. Metallic salts can be prepared from aluminum, calcium, lithium, magnesium, potassium, sodium and zinc.

The term “derivative” in chemistry refers to a compound that is obtained from a similar compound or a precursor compound by a chemical reaction.

In embodiments, the compounds described herein are obtained from natural components, extracts, supernatant or conditioned media, including but not limited to butyl phosphoramidate, other organic acids, and H₂O₂ produced by lactic acid producing bacteria, and the marine bacteria Aerococcus viridans (U.S. Pat. No. 10,188,113). As an example, the compounds are obtained from conditioned media or supernatant in which microorganisms are cultured or grown.

In embodiment, the compounds are sodium dodecylbenzenesulfonate (SDBS), sodium dodecyl sulfate (SDS), 4-Dodecylbenzenesulfonic acid (DBSA), butyl phosphoramidate (BPA), (4-aminophenetyl) dimethylphosphine oxide (APDMPO), dibutyl phosphate (DBP), or dibutyl phosphite (DBPT).

In embodiments, the one or more compounds are present in the composition at a concentration of between 0.01 μg/ml to 5000 μg/ml.

In embodiments, the one or more compounds described herein are antibiofilm agents.

U.S. Pat. No. 10,188,113 and International Applications PCT/US2017/020016 and PCT/US2017/039783, disclose compositions for use in the methods disclosed herein containing organophosphorous and/or organosulfurous compounds which have bacteriostatic, bactericidal, and antibiofilm properties and are useful to treat contamination.

In embodiments, the contamination is a single or multi-bacterial and/or fungal and/or algal and/or yeast and/or viral contamination.

As used herein, the term “antimicrobial” refers to a substance that destroys or inhibits the growth of microorganisms. As used herein, the term “antifouling” refers to a substance that destroys or inhibits the growth of foulers.

In embodiments, the contamination includes one or more bacteria, including waterborne bacteria. In embodiments the bacteria include but are not limited to, Campylobacter jejuni, Escherichia coli, Giardia lambia, Hepatitis A, Legionaella pneumophila, Salmonella enterica, and others, as well as Staphylococcus aureus, Staphylococcus epidermidis, Acinetobacter baumannii, Pseudomonas aeruginosa, Enterobacteriaceae, Salmonella bongori, Enterococcus faecium, Helicobacter pylon, Campylobacter spp., Neisseria gonorrhoeae, Streptococcus pneumoniae, Streptococcus mutans, Streptococcus gordonii, Streptococcus pyogenes, Haemophilus influenzae, Shigella spp., Klebsiella pneumoniae, Clostridium difficile, Bacillus anthracis, Yersinia pestis, Francisella tularensis, Burkholderia mallei, Burkholderia pseudomallei, Corynebacterium spp., Micrococcus luteus, Micrococcus lylae, Micrococcus roseus, Cutibaceterium acnes, Vibrio vulnificus, Vibrio cholerae, Vibrio parahaemolyticus, Propionibacterium acnes, Neisseria gonorrhoeae, Burkholderia cepacia, Burkholderia mallei, Burkholderia pseudomallei, Ralstonia pickettii, Cuprividus metalliduran, and/or biofilm-forming bacteria found on aquatic surfaces, including Cobetia marina and others.

In embodiments, the eukaryotic fouling contamination are caused by algae and microalgae, including Euglenophyta, Chrysophyta, Pyrrophyta, Chlorophyta, Rhodophyta, Paeophyta, and/or Xanthophyta, macroalgae, seaweed, blue green algae, plants, including sea grasses; and animals, including tunicates, mussels, oysters, clams, barnacles, cnidarians, sponges, and larvae. In embodiments, the fungal contamination is caused by fungi, including Zygomycota, Ascomycota, Basidiomycota, Deuteromycota, and others, and/or other eukaryotic foulers.

The term “effective amount” refers to an amount, concentration, or dosage sufficient to produce a desired result. The effective amount may vary depending on the organophosphorous compound, organosulfurous compound and antibiotic that is being used, and may also depend on a variety of factors and conditions related to the contamination being treated and the severity of the contamination. For example, if the composition is to be administered, factors to be considered include the type of organisms, size of the system, temperature, pH, etc. The determination of an effective amount is within the ability of those skilled in the art. In embodiments, the effective amount of organophosphorous compound and/or organosulfurous compound is administered at a concentration of 0.00001% to 5.0%. In embodiments, the organophosphorous compound and/or organosulfurous compound is administered at a concentration of 1.0% to 2.0%, 2.0% to 3.0%, 4.0 to 5.0%, 0.1% to 1%, 0.0005% to 0.5%, 0.0001% to 0.1%, 0.005% to 0.05%, 0.001% to 0.01%, 0.02% to 0.9%, 0.03% to 0.08%, 0.04% to 0.07%, or 0.05% to 0.06%.

In embodiments, an effective amount of the antimicrobial agent is administered at a concentration of 0.000001% to 0.05%. In embodiments, the biocide is administered at a concentration of 0.00001% to 0.0001%, 0.0005% to 0.005%, 0.001% to 0.01%, 0.01% to 0.04%, or 0.02% to 0.03%.

The use of one or more compounds in combination to treat contamination, provide significant benefits to treat a variety of organisms that contaminate fresh, salt and potable water systems. In embodiments, the organophosphorous or organosulfurous compounds are used in combination with an antimicrobial and/or sonication.

In embodiments, the antimicrobial agent may be oxidizing (halogenated, non-halogenated, and acid) biocides, metals (ionic or salts), and/or non-oxidizing biocides, ozonated water, acids, naturally occurring biocides such as chitosan, and/or plant derived compound.

In embodiments the biocides include, chlorine (free chlorine, hypochlorous acid, hypochlorite salts), chlorine dioxide, sodium chloride, bromine, iodine, hydrogen peroxide, chlorhexidine, bismuth thiols (e.g., bismuth ethanedithiol), potassium permanganate, peracetic acid, propionic salts, parabens, 2-(Decylthio)ethanamine (DTEA), glutaraldehyde, ortho-phthalaldehyde, tetrakish(hydroxymethyl)phosphonium sulfate (THPS), tributyltetradecylphosphonium chloride (TTPC), 2-Bromo-4-hydroxyacetopne (BHAP), 2-Bromo-2-nitropropane-1,3-diol (Bronopol), sodium dimethyldithiocarbamate (DIBAM), disodium ethylene bisdithiocarbamate (NIBAM), potassium n-hydroxymethyl-n-methyldithiocarbamate, 2,2 Dihydroxy-5,5-dichlorodiphenyl monosulfide (Chlorothioether), 2-2-Dibromo-3-nitrilopropionamide (DBNPA), methylene bis(thiocyanate) (MBT), polyquats (e.g., poly[oxyethylene (dimethyliminio)ethylene,dichloride]), quaternary ammonium compound (Quats) (e.g., alkyldimethylbenzylammonium chloride, ADBACs), sulfone (e.g., Bis(trichloromethyl) sulfone), bis(tributyltin) oxide (TBTO), 2-(tert-butylamino)-4-chloro-6-(ethylamino)-s-triazine (TBZ), tetrachloro-2,4,6-cyano-3-benzonitrile (TCCBN), 2(thiocyanomethylthio)benzothiazole (TCMTB), tetrahydro-3,5,dimethyl-2H-1,3,5-thiadiazine-2-thione, isothiazolines including 5-chloro-2-methyl-4-isothiazolin-3-one and 2-methyl-4-isothiazolin-3-one, and 1,2-benzisothiazolin-3-one (BIT), guanides, including, guanidine and biguanides (e.g., dodecylguanidine hydrochloride and acetate, polyhexamethylene biguanide hydrochloride, and/or tetradecylguanidine. In embodiments, the concentration of biocide is a concentration of between 0.01% to 5%, 0.01% to 0.1%, 0.1% to 1.0%, 1.0% to 2.0%, 2.0% to 3.0%, 3.0% to 4.0%, or 4.0% to 5.0%. In embodiments, the concentration of chlorine is a concentration of between 0.1 ppm to 50 ppm, 0.1 ppm to 1.0 ppm, 1.0 ppm to 5 ppm, 5 ppm to 10 ppm, 10 ppm to 20 ppm, 20 ppm to 30 ppm, 30 ppm to 40 ppm, or 40 ppm to 50 ppm.

In embodiments, the metal is silver, gold, copper, or zinc, or their derivatives. In embodiments the concentration of metal is administered at a concentration of 0.01% to 0.1%, 0.1% to 1.0%, 1.0% to 2.0%, 2.0% to 3.0%, 3.0% to 4.0%, or 4.0% to 5.0%. In embodiments, the silver compound is silver ions, silver particles, silver nanoparticles, metallic silver, colloidal silver, silver sulfate, and/or silver chloride. In embodiments, concentration of the silver is a concentration of between 0.01 ppm to 30 ppm, 0.01 ppm to 0.1 ppm, 0.1 ppm to 50 ppm, 0.1 ppm to 1.0 ppm, 1.0 ppm to 5 ppm, 5 ppm to 10 ppm, 10 ppm to 20 ppm, 20 ppm to 30 ppm. In embodiments, the zinc compound includes, zinc acetate, zinc octoate, zinc pyrithione, zinc sulfate, and/or zinc oxide. In embodiments, concentration of the zinc is a concentration of between 0.01 to 5%. In embodiments, the zinc is administered at a concentration of 0.01% to 0.1%, 0.1% to 1.0%, 1.0% to 2.0%, 2.0% to 3.0%, 3.0% to 4.0%, or 4.0% to 5.0%.

In embodiments, the concentration of chitosan is a concentration of between 0.01 to 5%. In embodiments, the chitosan is administered at a concentration of 0.01% to 0.1%, 0.1% to 1.0%, 1.0% to 2.0%, 2.0% to 3.0%, 3.0% to 4.0%, or 4.0% to 5.0%.

In embodiments, the concentration of acid is a concentration of between 0.01% to 5%. In embodiments, the acid is administered at a concentration of 0.01% to 0.1%, 0.1% to 1.0%, 1.0% to 2.0%, 2.0% to 3.0%, 3.0% to 4.0%, or 4.0% to 5.0%.

In embodiments, the plant derived compound includes orange essential oil, lemon essential oil, oregano essential oil, thyme essential oil, cinnamon essential oil, citral, cinnamaldehyde, carvacrol, thymol, citric acid, itaconic acid, aconitic acid, isocitric acid, succinic acid, fumaric acid, malic acid, glyoxylic acid, pyruvic acid, 2-oxoglutaric acid, 2-phosphoenolpyruvic acid, phosphoenolpyruvate carboxylase, glycolic acid, and/or aloe. In embodiments, concentration of plant derived compound is a concentration of between 0.01 to 5%, 0.01% to 0.1%, 0.1% to 1.0%, 1.0% to 2.0%, 2.0% to 3.0%, 3.0% to 4.0%, or 4.0% to 5.0%. In embodiments the acid is maleic acid, clavulanic acid, glucaric acid, formic acid, carboxylic acid, hypochlorous acid, and/or hydrochloric acid. In embodiments, concentration of acid is a concentration of between 0.001 to 5%, 0.001% to 0.01%, 0.01% to 0.1%, 0.1% to 1.0%, 1.0% to 2.0%, 2.0% to 3.0%, 3.0% to 4.0%, or 4.0% to 5.0%.

In embodiments, the organophosphorous or organosulfurous compounds are used in combination with an additional antibiofilm agent. In embodiments the antibiofilm agent includes but is not limited to an enzyme. In embodiments, the enzyme is N-acetyl-glucosaminidase, Deacetylase, Alginate lyases (mannuronate lyase or guluronate lyase), and DNase.

In embodiments, the organophosphorous or organosulfurous compounds and/or antimicrobials are used with sonication. In embodiments, the compounds are used with a sonicating brush, sonicating bath, and boat ultrasonic cleaner. In embodiments, the compounds are used after a surface is treated with sonication. In embodiments, the ultrasonic frequency is 20 kHz to 40 kHz.

The compositions described herein further include one or more surfactants, one or more antifoaming agents, one or more preservatives, one or more agents providing scent, one or more solvents, or a combination thereof.

In embodiments, the surfactant is an anionic, cationic, non-ionic, amphoteric, or a combination thereof. In embodiments, the surfactant is one that is approved for food contact by the Food and Drug Administration. Examples of one or more surfactant includes but is not limited to Alkyl (C8-C24) benzenesulfonic acid and its ammonium, calcium, magnesium, potassium, sodium, and zinc salts; C10-C18-Alkyl dimethyl amine oxides; α-alkyl(C6-C15)-ω-hydroxypoly(oxyethylene)sulfate, and its ammonium, calcium, magnesium, potassium, sodium, and zinc salts; α-alkyl (C12-C15)-ω-hydroxypoly (oxypropylene) poly (oxyethylene) copolymers, lauryl glucoside, decyl glucoside, coco/soy methyl ester, coco/soy methyl ester sulfonate, cocoalkyl amine oxide, cocamide MIPA, caprylyl/myristyl glucoside, and/or caprylyl/decyl glucoside. In embodiments, concentration of the surfactant is a concentration of between 0.001% to 30%. In embodiments, the surfactant is administered at a concentration of 0.001% to 0.05%, 0.05% to 0.5%, 0.1% to 1%, 1% to 10%, 10% to 20%, 20% to 30%, 5% to 10%, 2.0% to 3.0%, 4.0% to 5.0%, or 5.0% to 6.0%.

Examples of one or more antifoaming or defoaming agent includes but are not limited to, silicones, non-ionic emulsifiers, benzoic acid, SE-15™ octanols, polymers, C12-C18 alcohols, Xiameter™, SAG5693™, and SAG471™. In embodiments, the antifoam agent is administered at a concentration of between 0.001% to 1%. In embodiments, the antifoaming agent is administered at a concentration of 0.001% to 0.1%, 0.05% to 0.5%, 0.1% to 1.0%, or 0.5% to 1.0%.

Examples of one or more preservative includes but is not limited to, potassium sorbate, benzyl alcohol, carprylhydroxamic acid, caprylyl glycol, and dehydroacetic acid. In embodiments, concentration of the preservative is a concentration of between 0.00001% to 0.5%. In embodiments, the preservative is administered at a concentration of 0.0001% to 0.001%, 0.0005% to 0.005%, 0.01% to 0.1%, or 0.1% to 0.5%.

Examples one or more agent providing scent includes but are not limited to, orange, lemon, lime, elderberry, and lavender. In embodiments, concentration of the agent providing scent is a concentration of between 0.001% to 5%. In embodiments, the agent providing scent is administered at a concentration of 0.05% to 0.5%, 0.1% to 1.0%, 2.0% to 3.0%, 3.0% to 4.0%, or 4.0% to 5.0%.

Examples of one or more solvent includes but is not limited to, water, alcohol, acetic acid, acetic anhydride, acetone, citric acid, lactic acid, dioxolane, supernatant, cultured media, and growth media. In embodiments, concentration of the solvent is a concentration of between 1% to 99.999%. In embodiments, the solvent is administered at a concentration of 99.99% to 9.9%. 99.0% to 95.0%, 97.0% to 95.0%, 94.0% to 91.0%, 90.0% to 80.0%, 80.0% to 70.0%, 70.0% to 60.0%, 60.0% to 50.0%, 50.0% to 40.0%, 40.0% to 30.0%, 30.0% to 20.0%, 20.0% to 10.0%, or 10.0% to 1.0%.

Compositions of the present invention may optionally include one or more of the conventional additives known to be useful in water treatments and cleaners including viscosity modification agents, pH adjusters, foaming agents, water softening agents, emulsifiers, additional co-surfactants including anionic, cationic, nonionic, amphoteric, and zwitterionic surface active agents, additional organic solvents for stability purposes, chelating agents, cleaning enzymes, stabilizers, moisturizers, softening agents, antistatic agents, and coloring agents. The total weight of the additional additives may comprise up to 20% of the composition. The optional ingredients are well known to those of ordinary still in the art.

Further provided herein is a method of preventing and/or removing microorganisms on or surface, such as an industrial or household surface, the method comprising contacting a surface with a composition in an effective amount comprising one or more of an organophosphorous compound, organosulfurous compound, and antimicrobial.

In embodiments, the composition is a cleaning agent, dispersant, surfactant, wetting agent, emulsifier, anti-odor agent, freshener, agent to disrupt, remove, and/or prevent and/or inhibit biofilm; agent to disrupt, remove, prevent and/or remove fouling; agent to disrupt, remove, prevent, and/or inhibit microbial growth and kill microorganisms, including bacteria, fungi, viruses, and other microorganisms.

In embodiments, the composition improves soil removal from surfaces.

In embodiments, the composition is in an automatic or manually operated dispenser. In embodiments, the dispenser dispenses the composition on a surface or in water. In embodiments, the dispenser is for a handrail for a moving walkway or escalator.

The use of compounds described herein has been found to enhance the antibiotic properties of antimicrobials, including but not limited to methylisothiazolinone (MIT), 5-Chloro-2-methyl-4-isothiazolin-3-one (CMIT), and 1,2-benzisothiazolin-3-one (BIT), peracetic acid, glutaraldehyde, tetrakis(hydroxymethyl) phosphonium sulfate, sodium pyrithione (NaPT), decyl glucoside, lactic acid, potassium sorbate, orange essential oil, cinnamaldehyde, citral, carvacrol, pine oil, citric acid, elderberry, and/or acetic acid.

Combination treatment can result in antimicrobial synergy in which two or more antimicrobials at low concentrations work together resulting in a greater potency than if each antimicrobial was used separately.

In embodiments, a combination treatment is provided for the use in a method of treatment or inhibition of contamination, the method comprising administration of a composition to the site. In a first embodiment, the composition is formulated into a liquid dosage form. In a second embodiment, the composition is administered in a dry dosage form, more specifically a powder, pressed powder, or tablet. In a third embodiment, the composition is administered in a wetted dosage form, more specifically a paste.

In embodiments, a method is provided of treating, or preventing contamination in water, on a wetted surface, on a dry surface by administration of an effective amount of the compositions disclosed herein to water, wetted surfaces, or dry surfaces.

In embodiments, the organophosphorous and/or organosulfurous compounds used herein are in a solution buffered to a pH 4-5. In embodiments, the organophosphorous and/or organosulfurous compounds used herein are in a solution buffered to a pH 5-10. In embodiments, the organophosphorous and/or organosulfurous compounds are anionic, cationic, or nonionic.

In embodiments, the disclosure provides a method of the use of organophosphorous or organosulfurous compounds in combination to treat fouling, provide significant benefits to treat a variety of organisms that foul surfaces. In embodiments, the organophosphorous or organosulfurous compounds are used in combination with an antimicrobial and/or sonication.

In embodiments, the disclosure provides a method of the use of organophosphorous or organosulfurous compounds in combination to increase biomass and yields in fermentation, provide significant benefits to increase productivity of the facility. In embodiments, the organophosphorous or organosulfurous compounds are used in combination with an antimicrobial and/or sonication.

In embodiments, the composition acts to increase the growth rate, biomass, yield, and productivity of algae, yeast, fungal, and bacterial fermentation. The compound and/or composition can be used to reduce biofilm formation, fouling and/or clumping. The compound and/or composition can be used to clean or reduce contamination of the fermentation cultures, water, surfaces, equipment, or containers. The compound and/or composition can be used before, during, and/or after the fermentation process. The compound and/or composition can be used as a coating on fermentation system surfaces and equipment. The compound and/or composition can be used as an additional carbon source for the fermentation organisms. The compound and/or composition can be used as a dispersant. The compound and/or composition can be used as an additive to the growth media as a salt, acid, and/or pH adjuster. In embodiments, the species of algae include Chlamydomonas spp., Chlorella spp., Haematococcus spp., and Dunaliella spp. In embodiments, the species of yeast include Saccharomyces cerevisiae, Pichia pastoris and Candida albicans. In embodiments, the species of fungi include Aspergillus spp., Trichoderma spp. In embodiments, the species of bacteria and filamentous bacteria include Lactobacillus spp., Bifidobacterium spp., Bacillus spp., E. coli, Streptomyces spp., and/or Actinoplanes spp. In embodiments, the organophosphorous, organosulfurous compound or composition is administered at a concentration of between 0.0001% to 5%. In embodiments, the organophosphorous, organosulfurous compound or composition is administered at a concentration of 0.0001% to 0.05%, 0.005% to 0.5%, 0.001% to 0.005%, 0.005% to 0.01%, 0.01% to 0.1%, 0.1% to 1.0%, or 1.0% to 5.0%.

In embodiments, the composition consists of an antifoam agent. In embodiments, the antifoam agent is silicone based, non-silicone based, and contain polyether dispersions. In embodiments, the antifoam agent includes, SE-15, x, and x. SE-15 contains 10% active silicon and non-ionic emulsifiers. In embodiments, concentration of the antifoam agent is a concentration of between 0.001% to 1%. In embodiments, the solvent is administered at a concentration of 0.001% to 0.01%, 0.01% to 0.05%, 0.05% to 0.1%, 0.1% to 0.5%, or 0.5% to 1.0%.

In embodiments, the disclosure provides a method of the use of organophosphorous or organosulfurous compounds in combination with natural and/or synthesized water-borne, oil-borne, or light organic solvent chemical preservatives to increase the durability and resistance of wood, timber, wood structures, or engineered lumber from being destroyed by insects, fungi, other microorganisms, and/or climate and surrounding elements, etc. Application processes include pressure processes, non-pressure processes, such as spraying, soaking, dipping, bathing, brush and spray treatments, steeping, etc., and other processes and treatments.

Representative organophosphorus and organosulfurous compounds described herein include those shown below.

Some useful compounds of Formula I with biofilm dispersant, remover, antibiofilm, antifouling, antifungal, and/or antimicrobial activity include compounds having the following structures as shown in Table A.

TABLE A

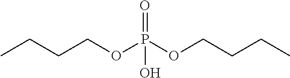

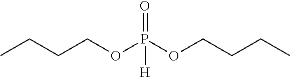

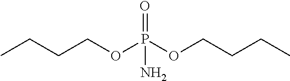

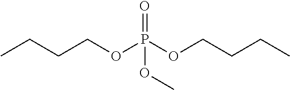

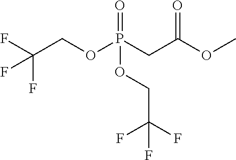 [SMILES: COC(=O)CP(=O)(OCC(F)(F)F)OCC(F)(F)F]

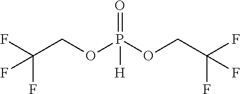 [SMILES: O=[PH](OCC(F)(F)F)OCC(F)(F)F]

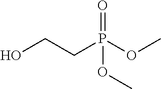

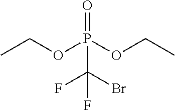

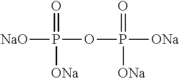

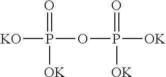

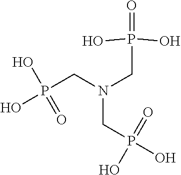 [SMILES: O=P(O)(O)CN(CP(=O)(O)O)CP(=O)(O)O]

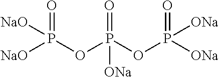

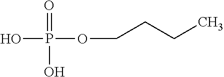

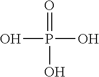

Compounds of Formula I may also include compounds having the following structures as shown in Table B.

TABLE B

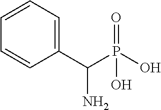 [SMILES: NC(c1ccccc1)P(=O)(O)O]

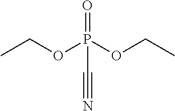

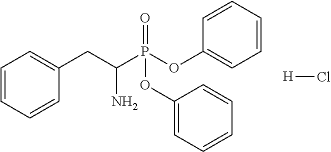

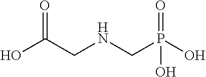

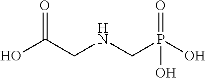

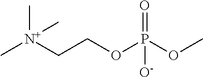

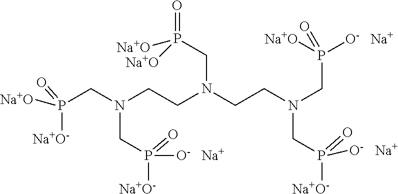

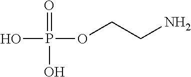

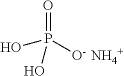

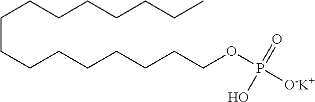

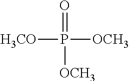

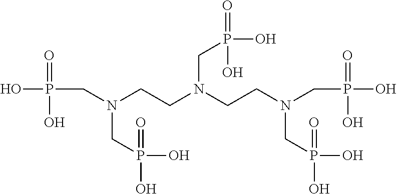 [SMILES: O=P(O)(O)CN(CCN(CP(=O)(O)O)CP(=O)(O)O)CCN(CP(=O)(O)O)CP(=O)(O)O]

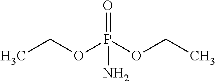

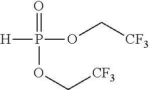 [SMILES: O=[PH](OCC(F)(F)F)OCC(F)(F)F]

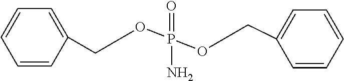 [SMILES: NP(=O)(OCc1ccccc1)OCc1ccccc1]

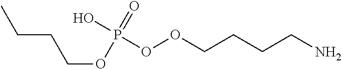

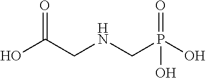

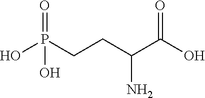 [SMILES: NC(CCP(=O)(O)O)C(=O)O]

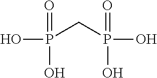

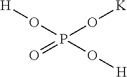

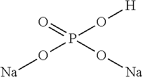

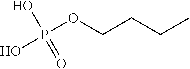

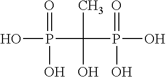

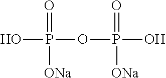

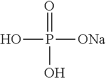

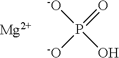

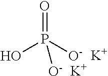

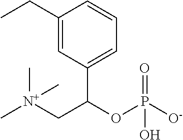 [SMILES: CCc1cccc(C(C[N+](C)(C)C)OP(=O)([O-])O)c1]

Compounds of Formula I may also include compounds having the following structures as shown in Table C.

TABLE C

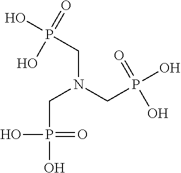 [SMILES: O=P(O)(O)CN(CP(=O)(O)O)CP(=O)(O)O]

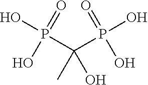

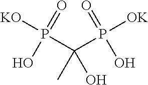

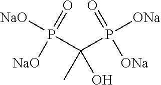

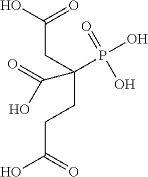 [SMILES: O=C(O)CCC(CC(=O)O)(C(=O)O)P(=O)(O)O]

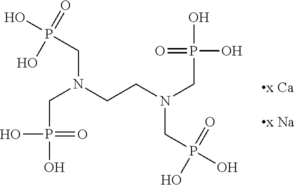 [SMILES: O=P(O)(O)CN(CCN(CP(=O)(O)O)CP(=O)(O)O)CP(=O)(O)O]

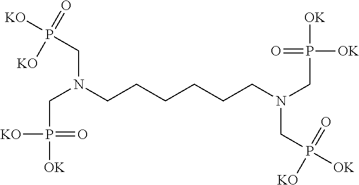

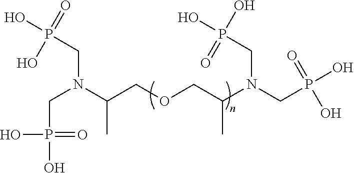

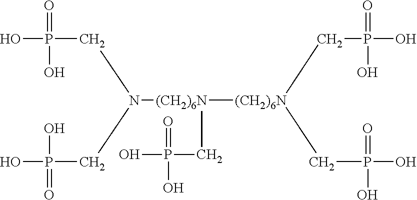

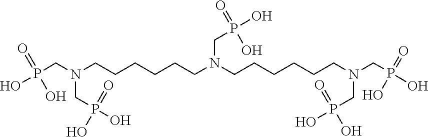 [SMILES: O=P(O)(O)CN(CCCCCCN(CP(=O)(O)O)CP(=O)(O)O)CCCCCCN(CP(=O)(O)O)CP(=O)(O)O]

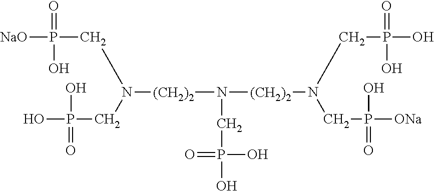

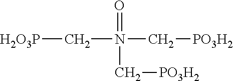

Compounds of Formula I may also include compounds having the following structures, as shown in Table D.

TABLE D

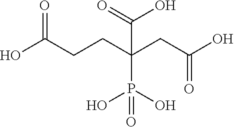 [SMILES: O=C(O)CCC(CC(=O)O)(C(=O)O)P(=O)(O)O]

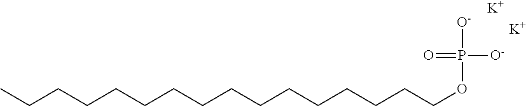 [SMILES: [K+] ; CCCCCCCCCCCCCCCCOP(=O)([O-])[O-] ; [K+]]

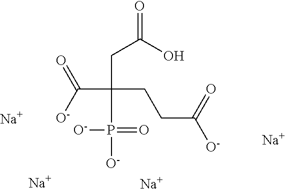 [SMILES: [Na+] ; O=C([O-])CCC(CC(=O)O)(C(=O)[O-])P(=O)([O-])[O-] ; [Na+] ; [Na+] ; [Na+]]

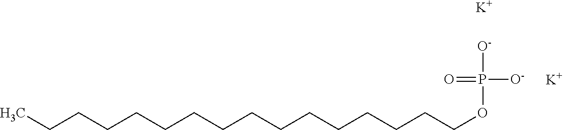 [SMILES: [K+] ; CCCCCCCCCCCCCCCCOP(=O)([O-])[O-] ; [K+]]

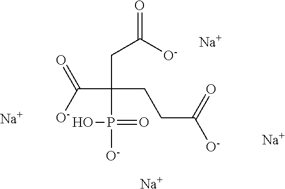 [SMILES: [Na+] ; O=C([O-])CCC(CC(=O)[O-])(C(=O)[O-])P(=O)([O-])O ; [Na+] ; [Na+] ; [Na+]]

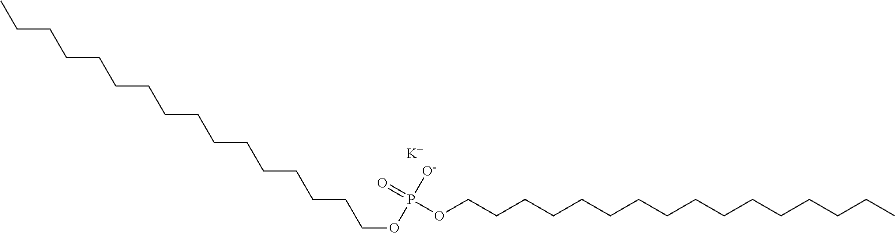 [SMILES: CCCCCCCCCCCCCCCCOP(=O)([O-])OCCCCCCCCCCCCCCCC ; [K+]]

OPO₃⁻² K⁺ K⁺

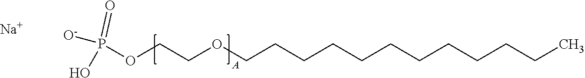

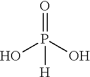

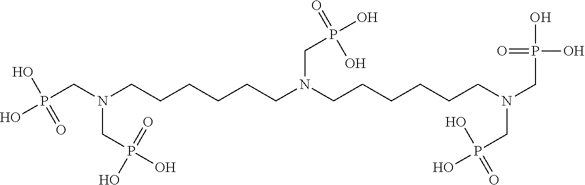 [SMILES: O=P(O)(O)CN(CCCCCCN(CP(=O)(O)O)CP(=O)(O)O)CCCCCCN(CP(=O)(O)O)CP(=O)(O)O]

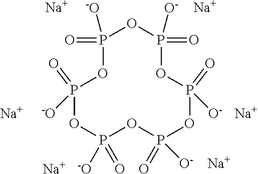

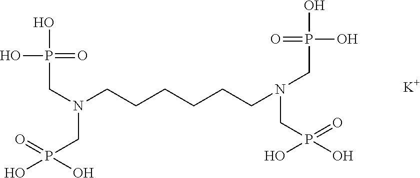 [SMILES: O=P(O)(O)CN(CCCCCCN(CP(=O)(O)O)CP(=O)(O)O)CP(=O)(O)O ; [K+]]

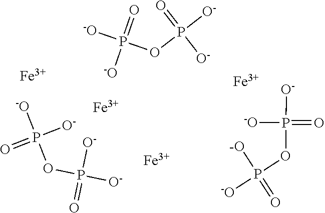

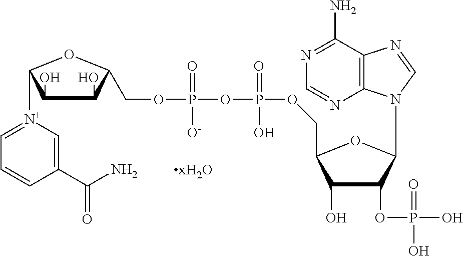

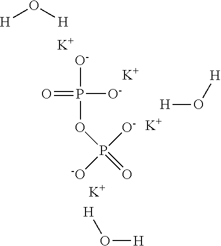

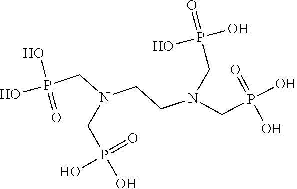 [SMILES: O=P(O)(O)CN(CCN(CP(=O)(O)O)CP(=O)(O)O)CP(=O)(O)O]

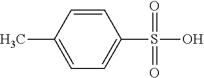

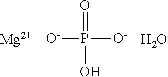

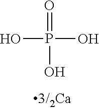

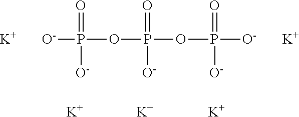 [SMILES: [K+] ; O=P([O-])([O-])OP(=O)([O-])OP(=O)([O-])[O-] ; [K+] ; [K+] ; [K+] ; [K+]]

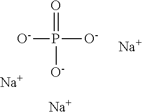

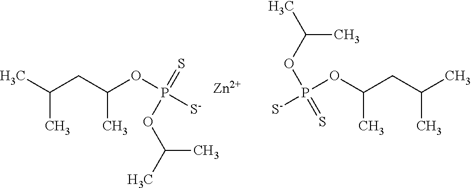

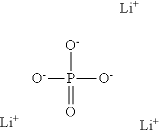

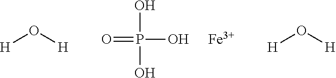

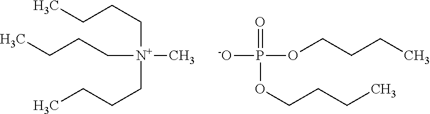

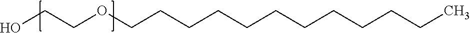

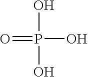

Some useful compounds of Formula II with dispersant, antibiofilm, antifouling, antifungal, and/or antimicrobial activity may include compounds having the following structures as shown in Table E.

TABLE E

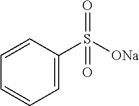

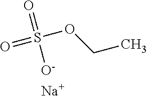

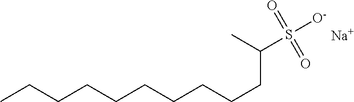 [SMILES: CCCCCCCCCCC(C)S(=O)(=O)[O-] ; [Na+]]

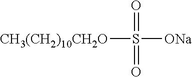

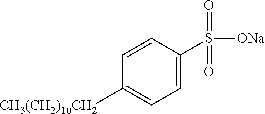

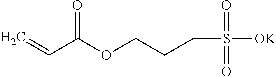

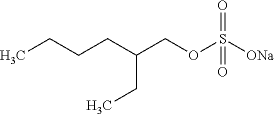

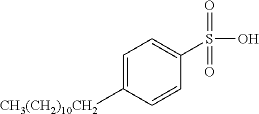

Compounds of Formula II may also include compounds having the following structures, as shown in Table F.

TABLE F

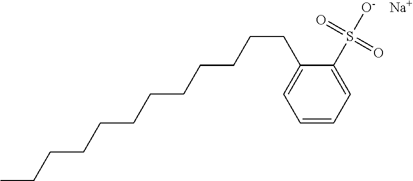 [SMILES: CCCCCCCCCCCCc1ccccc1S(=O)(=O)[O-] ; [Na+]]

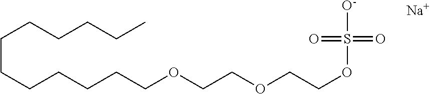 [SMILES: CCCCCCCCCCCCOCCOCCOS(=O)(=O)[O-] ; [Na+]]

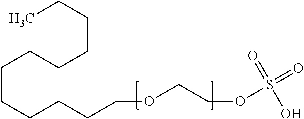

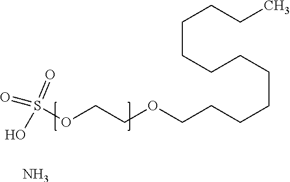

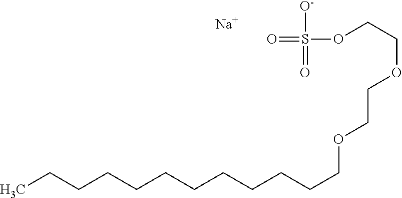 [SMILES: CCCCCCCCCCCCOCCOCCOS(=O)(=O)[O-] ; [Na+]]

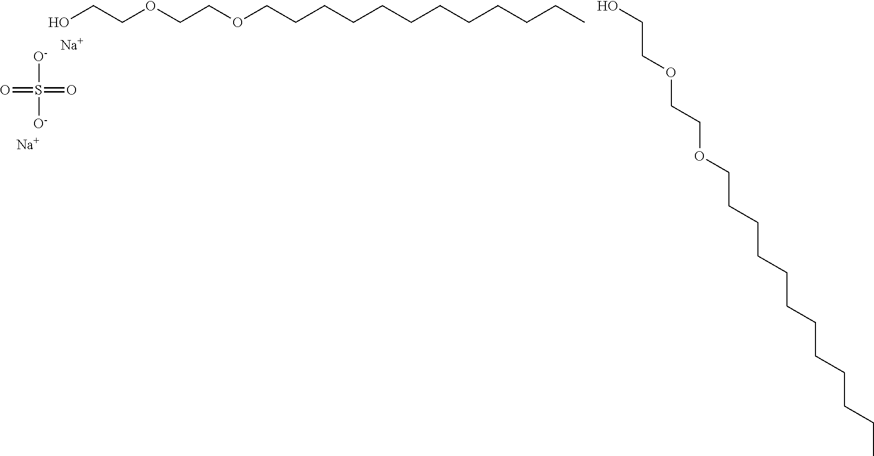

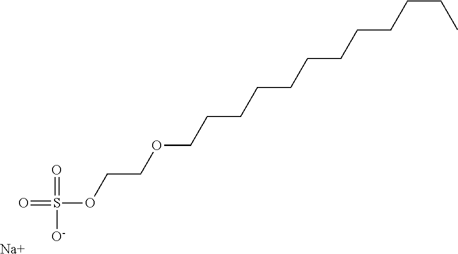 [SMILES: CCCCCCCCCCCCOCCOS(=O)(=O)[O-] ; [Na+]]

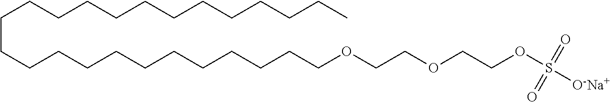

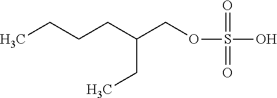

Other compounds useful in the methods of the present disclosure may include compounds having the following structures as shown in Table G.

TABLE G

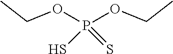

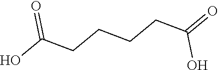

As will be understood by one of ordinary skill in the art, each embodiment disclosed herein can comprise, consist essentially of, or consist of its stated element, step, ingredient or component. Thus, the terms “include” or “including” should be interpreted to recite: “comprise, consist of, or consist essentially of.” The transition term “comprise” or “comprises” means includes, but is not limited to, and allows for the inclusion of unspecified elements, steps, ingredients, or components, even in major amounts. The transitional phrase “consisting of” excludes any element, step, ingredient or component not specified. The transition phrase “consisting essentially of” limits the scope of the embodiment to the specified elements, steps, ingredients or components and to those that do not materially affect the embodiment. In embodiments, lack of a material effect is evidenced by lack of a statistically-significant reduction in the embodiment's ability to perform a function, for example, preventing or treating microbial contamination or fouling.

In addition, unless otherwise indicated, numbers expressing quantities of ingredients, constituents, reaction conditions and so forth used in the specification and claims are to be understood as being modified by the term “about.” When further clarity is required, the term “about” has the meaning reasonably ascribed to it by a person skilled in the art when used in conjunction with a stated numerical value or range, i.e. denoting somewhat more or somewhat less than the stated value or range, to within a range of ±20% of the stated value; ±15% of the stated value; ±10% of the stated value; ±5% of the stated value; ±4% of the stated value; ±3% of the stated value; ±2% of the stated value; ±1% of the stated value; or ± any percentage between 1% and 20% of the stated value.

Recitation of ranges of values herein is merely intended to serve as a shorthand method of referring individually to each separate value falling within the range. Unless otherwise indicated herein, each individual value is incorporated into the specification as if it were individually recited herein. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.5, 2.7, 3, 4, 5, 5.1, 5.3, 5.8 and 6. This applies regardless of the breadth of the range. Moreover, any ranges cited herein are inclusive.

All methods described herein can be performed in any suitable order unless otherwise indicated herein or otherwise clearly contradicted by context.

The use of any and all examples, or exemplary language (e.g., “such as”) provided herein is intended merely to better illuminate the claimed subject matter and does not pose a limitation on the scope of claimed subject matter. No language in the specification should be construed as indicating any non-claimed element essential to the practice of the claimed subject matter.

Groupings of alternative elements or embodiments of the claimed subject matter disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

The following exemplary embodiments and examples illustrate exemplary methods provided herein. These exemplary embodiments and examples are not intended, nor are they to be construed, as limiting the scope of the disclosure. It will be clear that the methods can be practiced otherwise than as particularly described herein. Numerous modifications and variations are possible in view of the teachings herein and, therefore, are within the scope of the disclosure.

### EXEMPLARY EMBODIMENTS

The following are exemplary embodiments:
1. A composition comprising one or more organophosphorous and/or organosulfurous compounds in an effective amount to clean a surface, to prevent formation of biofilm, to prevent fouling, to kill microbes, and/or to inhibit the growth of microbes.
2. The composition of embodiment 1, wherein the composition further includes one or more surfactant.
3. The composition of embodiment 1 or 2, wherein the composition further includes one or more solvents.
4. The composition of any one of embodiments 1-3, wherein the composition further includes one or more antimicrobial agents.
5. The composition of any one of embodiments 1-4, wherein the composition further includes one or more antifoaming agents.
6. The composition of any one of embodiments 1-5, wherein the composition further includes one or more preservatives.
7. The composition of any one of embodiments 1-6, wherein the composition further includes one or more pH adjusters.
8. The composition of any one of embodiments 1-7, wherein the composition further includes one or more agents providing scent.
9. The composition of any one of embodiments 1-8, wherein the one or more organophosphorous or organosulfurous compounds are antibiofilm agents.
10. The composition of any one of embodiments 1-9, wherein the amount of each component in the composition relative to the total weight of the composition is:
   one or more organophosphorous or organsulfurous compounds: 0.00001 wt % to 1.0 wt %,
   one or more antimicrobial agents: 0.000001 wt % to 5 wt %,
   one or more antifoaming agents: 0.001 wt % to 1 wt %,
   one or more surfactants: 0.001 wt % to 30 wt %,
   one or more preservatives: 0.00001 wt % to 0.5 wt %,
   one or more pH adjusters: 0 to 2 wt %,
   one or more agents providing scent: 0.001 wt % to 5 wt %, and
   one or more solvents: quality sufficient (Q.S.) to 100% solution.
11. The composition of any one of embodiments 1-10, wherein the composition is a cleaning agent, an antibiofilm agent, an antifouling agent, and/or an antimicrobial agent.
12. The composition of any one of embodiments 1-11, wherein the antimicrobial agent includes an antifungal agent, an antiviral agent, an antibacterial agent, an antiprotozoal agent, or a combination thereof.
13. A composition comprising one or more organophosphorous or organosulfurous compounds and growth culture medium.
14. The composition of embodiment 13, wherein the growth culture medium is for culturing yeast and/or algae.
15. A method of cleaning a surface, wherein the method includes applying the compositions of any one of embodiments 1-12 to the surface to clean the surface.
16. A method of preventing growth of microorganisms on a surface, wherein the method includes applying the compositions of any one of embodiments 1-12 to the surface.
17. The method of embodiment 15 or 16, wherein the surface is an inert surface, an organic surface, or a nano surface.
18. The method of any one of embodiments 15-17, wherein the surface is of a medical device, organism, industrial equipment, plant, animal, or human tissue.
19. The method of embodiment 18, wherein the medical device is an indwelling medical device.
20. The method of any one of embodiments 15-18, wherein the surface is of a living organism or dead organism.
21. The method of any one of embodiments 15-18 or 20, wherein the surface is of a human, animal, or plant.
22. The method of any one of embodiments 15-18, 20, or 21, wherein the surface is of a human or animal tissue or organ.
23. The method of embodiment 16, wherein the composition is an antifouling paint or coating.
24. A method of treating contaminants, wherein the method includes contacting the contaminants with the composition of any one of embodiments 1-12.
25. The method of embodiment 24, wherein treating the contaminants includes killing and/or preventing the growth of the contaminants.
26. The method of embodiments 24 or 25, wherein the contaminants are in a composition.
27. The method of any one of embodiments 24-26, wherein the contaminants are in a liquid or a liquid composition.
28. The method of any one of embodiments 24-27, wherein the contaminants are in water, sewage, yeast and algae fermentation broth, or other liquids used in industrial processes.
29. The method of any one of embodiments 24-28, wherein the composition is a cosmetic, personal beauty, or hygiene preparation.
30. A method of enhancing growth of yeast or algae, wherein the method includes adding the compounds or composition of any one of embodiments 1-12 to a culture containing yeast or algae.
31. The method of embodiment 30, wherein enhancing the growth of yeast or algae includes increasing yield of biomass of yeast or algae in the culture as compared to biomass of yeast or algae grown in the absence of the composition.
32. The composition or method of any one of embodiments 1-31, wherein the organophosphorous or organosulfurous compounds include sodium dodecylbenzenesulfonate (SDBS), sodium dodecyl sulfate (SDS), 4-Dodecylbenzenesulfonic acid (DBSA), butyl phosphoramidate (BPA), (4-aminophenetyl) dimethylphosphine oxide (APDMPO), dibutyl phosphate (DBP), or dibutyl phosphite (DBPT).
33. The composition or method of any one of embodiments 1-32, wherein the compound is an organophosphorous and/or organosulfurous compound of Formula I, Formula II, or Formula III, a salt thereof, a solvate thereof, or a derivative thereof, wherein
   (a) Formula I is

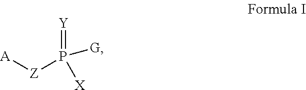

wherein,
   A is H, C₁₋₁₆ hydrocarbyl or optionally R¹ substituted C₁₋₁₆ hydrocarbyl; Z is O or a bond; Y is O; G is OH, H, C₁₋₆—COO-alkyl, —O—C₁₋₁₆ alkyl, R¹ substituted C₁₋₁₀ hydrocarbyl, CH₂NHCH₂COOH, or O-aryl; X is H, CN, —NHR, —NHOR, —NHOCOR, R¹ substituted C₁₋₁₀ hydrocarbyl or —OR; and R is H, C₁₋₁₀ hydrocarbyl, or optionally R¹ substituted C₁₋₁₀ hydrocarbyl;
   R¹ is selected from halogen, cyano, OH, C₁₋₆ hydrocarbyl, C₁₋₆ alkoxy, SOR², SO₂R², SO₂NR³R⁴, CONR³R⁴, NR³R⁴, NR³COR⁴, NR³SO₂R⁴, NR³CO₂R⁴, NR³CONR⁴, and phosphonic acid, wherein each of C₁₋₆ hydrocarbyl, C₁₋₆ alkoxy, SOR², SO₂R², SO₂NR³R⁴, CONR³R⁴, NR³R⁴, NR³COR⁴, NR³SO₂R⁴, NR³CO₂R⁴, NR³CONR⁴, can be optionally substituted with halo, amino, hydroxyl, C₁₋₆ hydrocarbyl, C₁₋₆ alkoxy, cyano, or phosphonic acid; and
   R², R³ and R⁴ are independently selected from hydrogen, C₁₋₆ hydrocarbyl, in which each of the C₁₋₆ hydrocarbyl can be optionally substituted with halo, amino, hydroxyl, C₁₋₆ alkoxy, cyano, or phosphonic acid;
      (b) Formula II is

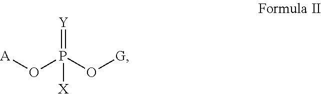

wherein,
   A is R, Y is O or S, X is NH2, OH, or OR, and G is R, where R is C₁₋₁₆ hydrocarbyl;
   R¹ is selected from halogen, cyano, OH, C₁₋₆ hydrocarbyl, C₁₋₆ alkoxy, SOR², SO₂R², SO₂NR³R⁴, CONR³R⁴, NR³R⁴, NR³COR⁴, NR³SO₂R⁴, NR³CO₂R⁴, NR³CONR⁴, and phosphonic acid, wherein each of C₁₋₆ hydrocarbyl, C₁₋₆ alkoxy, SOR², SO₂R², SO₂NR³R⁴, CONR³R⁴, NR³R⁴, NR³COR⁴, NR³SO₂R⁴, NR³CO₂R⁴, NR³CONR⁴, can be optionally substituted with halo, amino, hydroxyl, C₁₋₆ hydrocarbyl, C₁₋₆ alkoxy, cyano, or phosphonic acid; and
   R², R³ and R⁴ are independently selected from hydrogen, C₁₋₆ hydrocarbyl, in which each of the C₁₋₆ hydrocarbyl can be optionally substituted with halo, amino, hydroxyl, C₁₋₆ alkoxy, cyano, or phosphonic acid; and
      (c) Formula III:

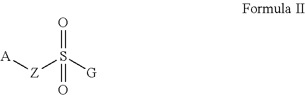

wherein
A is H, C₁₋₂₀ hydrocarbyl, alkylaryl, or optionally R¹ substituted C₁₋₂₀ hydrocarbyl; Z is 0 or a bond; G is OH, H, C₁₋₆—COO-alkyl, —O—C₁₋₆ alkyl, R¹ substituted C₁₋₁₀ hydrocarbyl, CH₂NHCH₂COOH, or O-aryl; R¹ is selected from halogen, cyano, OH, C₁₋₆ hydrocarbyl, C₁₋₆ alkoxy, SOR², SO₂R², SONR³R⁴, CONR³R⁴, NR³R⁴, NR³COR4, NR³SOR⁴, NR³COR⁴, NR³CONR⁴, and phosphonic acid, wherein each of C₁₋₆ hydrocarbyl, C₁₋₆ alkoxy, SOR², SO₂R², SO₂NR³R⁴, CONR³R⁴, NR³R⁴, NR³COR⁴, NR³SO₂R⁴, NR³CO₂R⁴, NR³CONR⁴, can be optionally substituted with halo, amino, hydroxyl, C₁₋₆ hydrocarbyl, C₁₋₆ alkoxy, cyano, or phosphonic acid; and R², R³ and R⁴ are independently selected from hydrogen, C₁₋₆ hydrocarbyl, in which each of the C₁₋₆ hydrocarbyl can be optionally substituted with halo, amino, hydroxyl, C₁₋₆ alkoxy, cyano, or phosphonic acid.
34. The compositions or methods of any one of embodiments 1-33, wherein the compositions include one or more derivatives, salts, or solvates of the one or more organophosphorous or organosulfurous compounds of Formula I, Formula II, or Formula III, or salts or solvates of the derivatives, or solvates of the salts of the derivatives.

### EXAMPLES

The following Examples are illustrative of specific embodiments of the disclosure, and various uses thereof. They are set forth for explanatory illustration only and are not to be construed as limiting on the disclosure in any way.

A primary objective of the present invention is to provide a cleaner, treatment, and booster for algae and yeast that has superior efficacy by incorporating an antibiofilm or antifouling compound. The antibiofilm molecules are hereby referred to as sodium dodecylbenzenesulfonate (SDBS), sodium dodecyl sulfate (SDS), sodium 2-ethylhexylsulfate (SEHS), 4-Dodecylbenzenesulfonic acid (DBSA), butyl acid phosphate (BAP), dibutyl phosphate (DBP), dibutyl phosphite (DBPT), Bis(2,2,2-trifluoroethyl) phosphite, Diethyl(Bromodifluoromethyl)phosphonate, synthetic butyl phosphoramidate BPA and natural components, including but not limited to BPA, other organic acids, and H₂O₂ produced by lactic acid producing bacteria, and the marine bacteria A. viridans.

The formula as set forth below as Example 1 is an example of compositions of an undiluted treatment. Example 1 may be made by dilution of a concentrate with water. The concentrate comprises on a weight basis: from about 1 to about 90% of an antibiofilm agent, from 0 to about 80% of a second antibiofilm agent, from 0 to about 80% of a surfactant, from 0 to about 90% of an antimicrobial, from 0 to about 90% of a second antimicrobial, from 0 to about 90% of a third antimicrobial, from 0 to about 10% of a preservative, from 0 to about 2% of an antifoam, from 0 to about 10% of a pH adjuster, from 0 to about 10% of a scent, and a solvent. The dilution may be 1:5, 1:10, 1:20, 1:30, 1:40, 1:50, 1:60, 1:70, 1:80, 1:90, 1:100, 1:1,000, 1:10,000, 1:100,000.

### Example 1

| Ingredient | Wt. % |
|---|---|
| Antibiofilm agent 1 | 0.00001-0.1 |
| Antibiofilm agent 2 | 0-1 |
| Surfactant | 0-4 |
| Antimicrobial 1 | 0-5 |
| Antimicrobial 2 | 0-5 |
| Antimicrobial 3 | 0-5 |
| Preservative | 0-0.5 |
| Antifoam | 0-0.1 |
| pH adjuster | 0-2 |
| Scent | 0-0.5 |
| Solvent | Q.S.¹ |

¹Quality sufficient to make 100% solution

### Antibiofilm and Antibacterial Characteristics of Compositions to Treat Water

The formula as set forth below as Examples 2-11.

| | EXAMPLES 2-11 | | | | |
|---|---|---|---|---|---|
| | Wt. % | | | | |
| Ingredient | E 2 | E 3 | E 4 | E 5 | E 6 |
| Antibiofilm | 0.00001-0.1¹ | 0.00001-0.1² | 0.00001-0.1³ | 0.00001-0.1⁴ | 0.00001-0.1⁵ |
| agent 1 | | | | | |
| Antibiofilm | | | | | |
| agent 2 | | | | | |
| Antimicrobial 1 | 0-0.25¹² | 0-0.25¹² | 0-0.25¹² | 0-0.25¹² | 0-0.25¹² |
| Antimicrobial 2 | 0-0.0075¹³ | 0-0.0075¹³ | 0-0.0075¹³ | 0-0.0075¹³ | 0-0.0075¹³ |
| Antimicrobial 3 | 0-0.04¹⁴ | 0-0.04¹⁴ | 0-0.04¹⁴ | 0-0.04¹⁴ | 0-0.04¹⁴ |
| Antimicrobial 4 | 0-1¹⁷ | 0-1¹⁷ | 0-1¹⁷ | 0-1¹⁷ | 0-1¹⁷ |
| Antifoam | 0-0.06⁹ | 0-0.06⁹ | 0-0.06⁹ | 0-0.06⁹ | 0-0.06⁹ |
| Solvent¹⁰ | Q.S.¹¹ | Q.S.¹¹ | Q.S.¹¹ | Q.S.¹¹ | Q.S.¹¹ |
| | EXAMPLES 2-11 | | | | |
| | Wt. % | | | | |
| Ingredient | E 7 | E 8 | E9 | E10 | E11 |
| Antibiofilm | 0.00001-0.1⁶ | 0.00001-0.1⁷ | 0.00001-0.1⁸ | 0.00001-0.1¹⁵ | 0.00001-100¹⁶ |
| agent 1 | | | | | |
| Antibiofilm | | | | | |
| agent 2 | | | | | |
| Antimicrobial 1 | 0-0.25¹² | 0-0.25¹² | 0-0.25¹² | 0-0.25¹² | 0-0.25¹² |
| Antimicrobial 2 | 0-0.0075¹³ | 0-0.0075¹³ | 0-0.0075¹³ | 0-0.0075¹³ | 0-0.0075¹³ |
| Antimicrobial 3 | 0-0.04¹⁴ | 0-0.04¹⁴ | 0-0.04¹⁴ | 0-0.04¹⁴ | 0-0.04¹⁴ |
| Antimicrobial 4 | 0-1¹⁷ | 0-1¹⁷ | 0-1¹⁷ | 0-1¹⁷ | 0-1¹⁷ |
| Antifoam | 0-0.06⁹ | 0-0.06⁹ | 0-0.06⁹ | 0-0.06⁹ | 0-0.06⁹ |
| Solvent¹⁰ | Q.S.¹¹ | Q.S.¹¹ | Q.S.¹¹ | Q.S.¹¹ | Q.S.¹¹ |

¹SDBS
²SDS
³SEHS
⁴DBSA
⁵BAP
⁶DBPT
⁷Bis(2,2,2-trifluoroethyl) phosphite
⁸Diethyl(Bromodifluoromethyl)phosphonate
⁹SE-15 (Sigma)
¹⁰water
¹¹Quality sufficient to make 100% solution
¹²BIT
¹³CMIT, 5-Chloro-2-methyl-4-isothiazolin-3-one
¹⁴Glutaraldehyde or Tetrakis(hydroxymethyl) phosphonium sulfate
¹⁵BPA
¹⁶Natural products produced by A. viridans or A. viridans supernatant
¹⁷NaPT, Sodium pyrithione

### Test Methods

Since the antimicrobial and antibiofilm activity is an important indicator of potential value of the treatment, the examples above were subject to the standard antimicrobial and antibiofilm test methods. Typical bacteria known to be related to contamination of water, liquids, cosmetics, and surfaces were tried in these tests. Seven bacterial species were obtained from the American Type Culture Collection (ATCC) (ATCC; Manassas, VA): E. coli (EC) ATCC 11775, S. aureus (SA) ATCC 12600, S. aureus Methicillin-Resistant (MRSA) ATCC 33591, A. niger (AN) ATCC 16888, C. marina (CM) ATCC 25374, Lactobacillus fermentum, strain 36 (ATCC 9338) and L. delbrueckii, subs. Delbrueckii, strain 730 (ATCC 9649). The following three reagents were obtained through Biodefense and Emerging Infections Research Resources Repository (BEI Resources), NIAID, NIH: Staphylococcus aureus, Strain AIS2006045 AKA VRS7, Vancomycin-Resistant (VRSA) NR-46417; Pseudomonas aeruginosa, P179, NR-31041, Multi-drug Resistant; and E. coli serotype O157:H7 ATCC 51657, NR-8, Multi-drug Resistant. Burkholderia cepacian (BC) ATCC 25416, Ralstonia pickettii (RP) ATCC 27511, and silver-resistant Cuprividus metallidurans (CM) ATCC 43123 were obtained from the NASA Marshall Space Flight Center. Microorganisms were cultured Tryptic Soy Broth (BD Bacto) growth medium prepared as per the manufacturer's instructions unless otherwise stated. Lactobacillus fermentum and L. delbrueckii were cultured in Lactobacillus MRS culture media (BD Difco) prepared as per the manufacturer's instructions. Overnight cultures of bacterial strains were adjusted to final target inoculum concentrations between 10⁵-10⁷ CFU/ml. For the test methods, E. coli, P. aeruginosa, S. aureus were cultured at 37° C. for 24-hours. A. niger, B. cepacian, R. pickettii, and C. metallidurans were cultured at 30° C. for 2-3 days.

Minimum inhibitory concentration (MIC) broth microdilution method was performed according to CLSI guidelines (CLSI M07-A10: Methods for Dilution Antimicrobial Susceptibility Tests for Bacteria that Grow Aerobically; Approved Standard—Tenth Edition). Assays were performed in duplicates on more than one occasion in a 96 well microtiter plate. The treatments were tested at a range of concentrations that were compared to controls that contained the appropriate media without the presence of any inhibitor. Turbidity (growth) was either measured visually or in a SpectraMax i3 Pate Reader (Molecular Devices) at 600 nm. The MIC of an inhibitor was determined by the lowest concentration without visible growth.

Minimum bactericidal concentration (MBC) was performed according to CLSI guidelines (CLSI M26-A: Methods for Determining Bactericidal Activity of Antimicrobial Agents; Approved Guideline).

Biofilm inhibition imaging was determined by growing bacteria in a black-walled optically-clear bottom 96 well plate (Nunc) at a 45° angle to promote biofilm formation prior to imaging. The treatments were tested at a range of concentrations: 0.24, 0.12, 0.06, 0.03, 0.015, 0.007, 0.0038, 0.0019% (v/v). After incubation with the treatments, the culture media was removed and the remaining adhered biofilm was stained with a two-color fluorescent stain using the FilmTracer LIVE/DEAD Biofilm Viability Kit (Molecular Probes) for 30 minutes and then biofilm was washed with sterile water. The live cells in the biofilm are stained green with SYTO 9 green fluorescent nucleic acid stain and dead cells are stained red with the red-fluorescent nucleic acid stain, propidium iodide. Images of the biofilms were taken with a Cytation 5 Cell Imaging Reader (Olympus) at excitation/emissions of 469/525 nm for SYTO 9 green and 531/593 nm for propidium iodide. These were compared to control biofilms that contained the appropriate growth media and bacteria without the presence of any inhibitor.

Minimum biofilm eradicating concentration (MBEC) was performed according to the ASTM standard (ASTM E2799-12; Standard Test Method for Testing Disinfectant Efficacy against Pseudomonas aeruginosa Biofilm using the MBEC Assay). Assays were performed in duplicates on more than one occasion.

The antimicrobial test results for the compounds are presented in Table 1.

TABLE 1
Antibacterial activity against E. coli ATCC 11775,
P. aeruginosa NR-31041, S. aureus ATCC 12600,
MRSA ATCC 33591, and A. niger ATCC 16888, as minimum
concentration needed to inhibit the growth.

| | Minimum Inhibitory Concentration (MIC) | | | | |
|---|---|---|---|---|---|
| | M07-09 Method (% v/v) | | | | |
| Treatment | EC | PA | SA | MRSA | AN |
| Natural BPA Supernatant | 0.005 | — | 0.005 | 0.005 | |
| SDBS | — | — | <0.004 | <0.003 | <0.003 |
| SDS | 0.100 | 0.500 | 0.028 | 0.028 | 0.030 |
| SEHS | | 0.500 | 0.280 | | |
| DBSA | 0.100 | 0.500 | 0.003 | 0.003 | 0.003 |
| DBPT | 0.040 | — | 0.010 | — | — |
| Bis(2,2,2-trifluoroethyl) | 0.500 | — | — | — | — |
| phosphite | | | | | |
| Diethyl | 0.100 | 0.100 | — | — | — |
| (Bromodifluoromethyl) | | | | | |
| phosphonate | | | | | |

The antimicrobial test results for the composition as a water treatment are presented in Table 2.

TABLE 2
Antibacterial activity against P. aeruginosa NR-31041,
as minimum concentration needed to inhibit the growth.

| | Minimum Inhibitory |
|---|---|
| | Concentration (MIC) |
| | M07-09 Method |
| | (% v/v) |
| Treatment | PA |
| SDBS + BIT (0.0078%) | 0.0078 |
| SDBS + BIT (0.0078%) + | 0.0078 |
| NaPT (0.03%) | |
| SDBS + Kathon 886F | 0.0078 |
| 14% (0.0025%) | |

¹ Kathon 886F 14%, active ingredients CMIT (10.6-10.8%) + MIT (3.43-3.47%)

The antimicrobial test results for the composition as a water treatment are presented in Table 3.

TABLE 3
Antibacterial activity against mixed species Burkholderia cepacia,
Ralstonia pickettii, and silver-resistant Cuprividus metallidurans.

| | | | % Reduction |
|---|---|---|---|
| | Concentration | | Compared |
| Treatment | (% v/v) | CFU/ml | to Control |
| SDBS + Antifoam | 0.03 | <1E+02¹ | 99.999% |
| SE15 (0.015%) | | | |
| SDS + Antifoam | 0.055 | <1E+02¹ | 99.999% |
| SE15 (0.03%) | | | |
| DBSA + Antifoam | 0.07 | <1E+02¹ | 99.999% |
| SE15 (0.03%) | | | |
| BAP + Antifoam | 1.15 | <1E+02¹ | 99.999% |
| SE15 (0.03%) | | | |
| DBPT + Antifoam | 0.29 | <1E+02¹ | 99.999% |
| SE15 (0.03%) | | | |
| Bis(2,2,2-trifluoroethyl) | 1.15 | <1E+02¹ | 99.999% |
| phosphite + | | | |
| Antifoam SE15 (0.03%) | | | |
| Diethyl | 0.58 | <1E+02¹ | 99.999% |
| (Bromodifluoromethyl) | | | |
| phosphonate + | | | |
| Antifoam SE15 (0.03%) | | | |

¹Detection limit is <1E+02

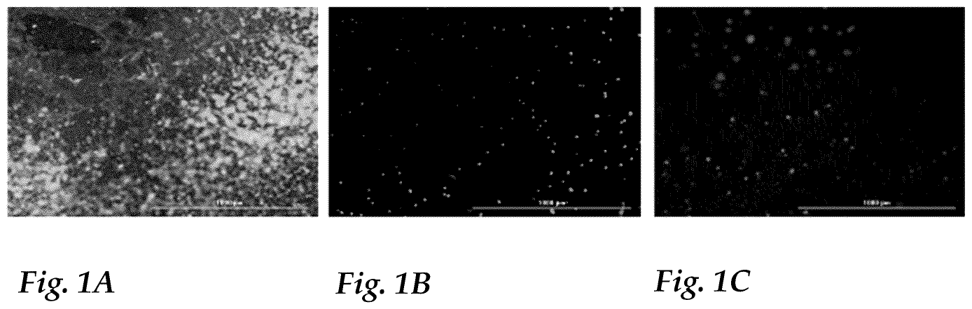

Antibiofilm activity against mixed species Burkholderia cepacia, Ralstonia pickettii, and silver-resistant Cuprividus metallidurans was determined for SDBS+Antifoam SE15 formula using the FilmTracer LIVE/DEAD Biofilm Viability Kit (Molecular Probes). The antibiofilm results are in FIGS. 1A, 1B, and 1C showing untreated bacteria forming a thick biofilm after 3 days (A). SDBS+Antifoam SE15 inhibited biofilm growth at 0.0038% (v/v) (B) and killed bacteria at 0.007% (v/v) (C). Live cells in the biofilm are stained green with SYTO 9 green fluorescent nucleic acid stain and dead cells are stained red with the red-fluorescent nucleic acid stain, propidium iodide. The MBIC of an inhibitor was determined by the lowest concentration required to prevent biofilm formation.

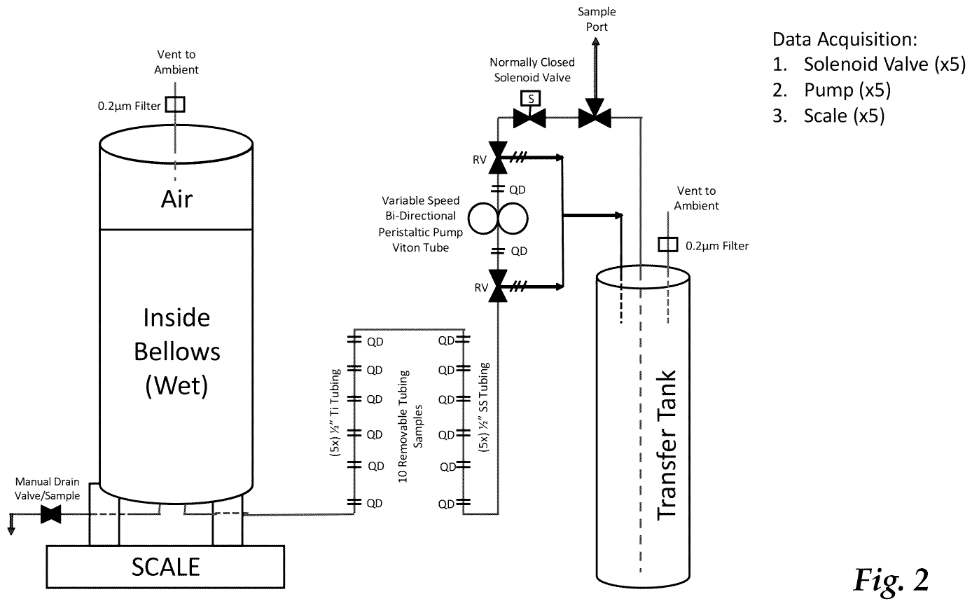

Based on these series of results against Burkholderia cepacia, Ralstonia pickettii, and silver-resistant Cuprividus metallidurans, SDBS 0.06%+Antifoam SE15 0.003% formula were used to determine its biofilm management efficacy in wastewater tanks at a configuration similar to that currently employed for the Water Processor Assembly (WPA). In this Phase, five tanks were filled with 55 L of wastewater ersatz (Table 4) and a mixed species inoculum concentration of 1×10⁵ CFU/ml. Two tanks were designated as control tanks (Tank 1 and Tank 5), for which no treatment was added. Two had an SDBS concentration of 0.06%, and one had an SDBS concentration of 0.05%. These periodically cycle back and forth from a transfer tank, mimicking the cycling process on the WPA. The schematic for this cycling process for an individual tank is laid out in FIG. 2. Samples (20 ml) were taken from the sample port on Day 1 and throughout the study. Turbidity (growth) was either measured visually or in a SpectraMax i3 Pate Reader (Molecular Devices) at 600 nm. To confirm microbial identification of the bacteria in the control tanks, the bacteria were observed visually and by microscopy methods using a Gram Stain Kit (Fisher) according to manufacturer's instructions and a light microscope (Nikon Eclipse TS100) and identified to the genus level using the EMSL Method MICRO-SOP-132 at EMSL Analytical, Inc. (Cinnaminson, NJ).

TABLE 4
Ersatz water formula

| | | | Final |
|---|---|---|---|
| Constituent | Amount | Unit | Volume |
| Organic Concentrate (200 mL) 0.33% of 60 L | | | |
| Propylene Glycol | 6.798 | mL | 4 L |
| Ethanol | 6.7427 | mL | |
| Acetone | 1.3667 | mL | |
| 2-(2-butoxyethoxy) Ethanol (DGME) | 942.2 | uL | |
| N,N-dimethylformamide | 594.4 | uL | |
| 2-Ethoxyethanol | 521.3 | uL | |
| 1-Methyl-2-Pyrrolidinone | 312.8 | uL | |
| 2-Propanol | 102.1 | uL | |
| 1-Propanol | 99.5 | uL | |
| 4-Ethylmorpholine | 90.6 | uL | |
| Benzoic Acid | 1.206 | g | |
| Caprolactam | 0.4444 | g | |
| Urea | 0.241 | g | |
| Inorganic Concentrate (200 mL) 0.33% of 60 L | | | |
| Potassium Chloride | 60.78 | g | 4 L |
| Ammonium Bicarbonate | 12.0006 | g | |
| Sodium Fluoride | 352 | mg | |
| Potassium Iodide | 104 | mg | |
| Acetate Concentrate (200 mL) 0.33% of 60 L | | | |
| Zinc (II) Acetate dihydrate | 10.12 | g | 4 L |
| Nickle (II) Acetate tetrahydrate | 2.1082 | g | |
| Direct Addition Concentrate (4 L) 6.7% of 60 L | | | |
| Calcium Sulfate | 269.39 | mg | 4 L |
| Methyl Sulfone | 12.24 | mg | |
| Hexamethylcyclotrisiloxane | 61.22 | mg | |
| Benzyl alcohol | 848.48 | uL | |
| Diethylphthalate | 120.6 | uL | |
| Trimethylsilanol | 521.3 | uL | |
| Benzothiazole | 12.5 | uL | |
| 2-Ethyl-1-hexanol | 28.92 | uL | |
| Decamethylcyclopentasiloxane | 61.86 | uL | |
| Dodecamethylcyclohexasiloxane | 60 | uL | |
| Octamethylcyclotetrasiloxane | 61.22 | uL | |
| Dimethoxydimethylsilane | 2106 | uL | |

The antibiofilm treatment SOBS at 0.06% (Tank 2 and Tank 3) and 0.05% (Tank 4) inhibited the growth of the mixed species biofilm forming bacteria (B. cepacia, R. pickettii, and silver-resistant C. metallidurans) with a 5-log (99.999%), 5-log (99.999%), and 4-log (99.99%), reduction respectively. The inhibition occurred rapidly, within the first day. The activity was sustained with a single treatment for over 8 months (Table 5).

TABLE 5
Antibacterial activity of SDBS in Tank 2 (0.06%
v/v), Tank 3 (0.06% v/v), and Tank 4 (0.05% v/v).

| | Average | | Percent |
|---|---|---|---|
| SDBS | Enumeration | Log | Reduction |
| Concentration | (CFU/ml) | Reduction | (%) |
| Tank 2 (0.06%) | <1E+01* | 5 | 99.999 |
| Tank 3 (0.06%) | <1E+01* | 5 | 99.999 |
| Tank 4 (0.05%) | <1E+01* | 4.4 | 99.99 |

*Detection limit is 1E+02 CFU/ml

### Antibiofilm and Antibacterial Characteristics of Compositions to Clean Surfaces

The composition comprises one or more organophosphorous and/or organosulfurous compounds, one or more antimicrobial, and/or one or more surfactant, antibiofilm agent, preservative, pH adjuster, agent providing scent, and solvent.

The formulas as set forth below as Examples 12-19 were chosen because they showed low to no streaks on hard surfaces including glass and stainless steel. The formulas were tested for filming/streaking performance on glass mirror and stainless steel surfaces. A grading scale of 1 to 5 was used, with 1 being the worst and 5 being the best (data not shown).

The formula as set forth below as Example 12-19 are examples of compositions of an undiluted treatment. Example 12-19 may be made by dilution of a concentrate with water. The concentrate comprises on a weight basis: from about 1 to about 10% of an antibiofilm agent, from 0 to about 10% of a second antibiofilm agent, from 0 to about 10% of a surfactant, from 0 to about 20% of an antimicrobial, from 0 to about 20% of a second antimicrobial, from 0 to about 20% of a third antimicrobial, from 0 to about 5% of a preservative, from 0 to about 10% of a pH adjuster, from 0 to about 10% of a scent, and a solvent. The dilution may be 1:1, 1:3, 1:7, 1:10, 1:12, 1:15, 1:20, 1:31, 1:63, 1:127, 1:255, and 1:512.

| | Examples 12-19 | | | | | | | |
|---|---|---|---|---|---|---|---|---|
| | Wt. % | | | | | | | |
| Ingredient | E 12 | E 13 | E 14 | E 15 | E 16 | E 17 | E18 | E19 |
| Antibiofilm | 0.001- | 0.001- | 0.001- | 0.001- | 0.001- | 0.001- | 0.001- | 0.001- |
| agent 1 | 0.1¹ | 0.1¹ | 0.1¹ | 0.1¹ | 0.1¹ | 0.1¹ | 0.1¹ | 0.1¹ |
| Antibiofilm | 0- | 0- | 0- | 0- | 0- | 0- | 0- | 0- |
| agent 2 | 98¹⁵ | 99¹⁵ | 96¹⁵ | 90¹⁵ | 89¹⁵ | 90¹⁵ | 96¹⁵ | 91¹⁵ |
| Surfactant | 1² | 0 | 2² | 2² | 1.5² | 4² | 2² | 2² |
| Antimicrobial 1 | 1³ | 1³ | 1³ | 5¹¹ | 5¹¹ | 5¹¹ | 1³ | 5¹¹ |
| Antimicrobial 2 | 0 | 0 | 0 | 2⁹ | 2¹⁰ | 0 | 0.25¹⁶ | 0.25¹⁶ |
| Antimicrobial 3 | 0 | 0 | 0 | 0 | 0 | 0 | 0-1¹⁷ | 0-1¹⁷ |
| Preservative | 0 | 0 | 0 | 0.1⁴ | 0 | 0 | 0 | 0.1⁴ |
| pH adjuster | 0 | 0 | 0 | 0 | 2⁶ | 0 | 0 | 0 |
| Scent | 0 | 0 | 0.02⁷ | 0.02⁷ | 0 | 0.02⁷ | 0.02⁷ | 0.02⁷ |
| Solvent | Q.S.⁵ | Q.S.⁵ | Q.S.⁵ | Q.S.⁵ | Q.S.⁵ | Q.S.⁵ | Q.S.⁵ | Q.S.⁵ |

¹SDBS or DBSA
²Decyl glucoside
³Lactic acid
⁴Potassium sorbate
⁵Quality sufficient to make 100% solution
⁶Sodium carbonate
⁷Orange Essential Oil
⁸ Water
⁹Citric Acid
¹⁰Elderberry
¹¹Acetic acid
¹⁵BPA or Natural products produced by A. viridans or A. viridans supernatant
¹⁶BIT
¹⁷NaPT, Sodium pyrithione

The antimicrobial test results for compositions are presented in Table 6.

TABLE 6
Antibacterial Activity Against E. coli, P. aeruginosa,
S. aureus, and MRSA as minimum concentration needed
to inhibit the growth of the bacteria.

| | Minimum Inhibitory Concentration (MIC) | | | |
|---|---|---|---|---|
| | M07-09 Method | | | |
| | Final Dilution in Water | | | |
| Treatment | EC | PA | SA | MRSA |
| SDBS (0.1%) + Decyl | 1:7 | 1:7 | 1:15 | 1:15 |
| glucoside (1%) + | | | | |
| Lactic acid (1%) | | | | |
| SDBS (0.01%) + | 1:3 | 1:7 | 1:15 | 1:15 |
| Lactic acid (1%) | | | | |

### Antibiofilm and Antibacterial Characteristics of Compounds to Treat Marine Fouling

### Example 20. Antibiofilm, Antibacterial, and Antifouling Molecules Remove Biofilm Formed by a Common Marine Bacterial Biofilm Former and Inhibit the Growth of Algae

The composition comprises one or more organophosphorous and/or organosulfurous compounds, one or more antimicrobial, and/or antibiofilm agent, antifouling agent, preservative, pH adjuster, in a coating or paint.

The MIC broth microdilution method was used to determine the minimum concentration needed to inhibit the growth of a common marine bacterial biofilm former C. marina. The MBC method was used to determine the minimum concentration needed to kill C. marina. The MBEC method was used to determine the minimum concentration needed to remove existing 24-hour and 48-hour biofilm formed by C. marina after 30 min exposure time. Percent biofilm efficacy and Log₁₀ Reduction was determined for SDBS and DBSA for concentrations (% v/v): 0.5000, 0.2500, 0.1250, 0.0630, 0.0313, 0.0156, and 0.0078.

The molecules DBP, DBPT, SDBS, SEHS, and DBSA, inhibited growth of marine biofilm former C. marina (Table 7). The molecules DBP, DBPT, SDBS, SEHS, and DBSA, killed C. marina 99.9999% (Table 7).

TABLE 7
Values of antibacterial and antibiofilm
activity against C. marina ATCC 25374.

| | Antibacterial Activity Against | | | |
|---|---|---|---|---|
| | C. marina ATCC 25374 | | | |
| | Minimum | Minimum | | |
| | Inhibitory | Bactericidal | | |
| | Concentration | Concentration | | % Reduction |
| Materials | (% v/v) | (% v/v) CLSI | | Compared to |
| in water | M07-09 Method | M26-A Method | CFU/ml | Control |
| DBP | 0.1250 | 0.5000 | <1E+02¹ | 99.9999% |
| DBPT | 0.1250 | 0.5000 | <1E+02¹ | 99.9999% |
| SDBS | 0.0078 | 0.0078 | <1E+02¹ | 99.9999% |
| SEHS | 0.0313 | 0.0630 | <1E+02¹ | 99.9999% |
| DBSA | <0.0039 | 0.0078 | <1E+02¹ | 99.9999% |

¹Detection limit is <1E+02
DBP and DBPT removed existing 24-hour and 48-hour biofilm 99.9999% formed by C. marina (Table 8).

TABLE 8
Values of antibacterial and antibiofilm
activity against C. marina ATCC 25374.

Antibiofilm Activity Against
C. marina ATCC 25374
24- and 48-hour biofilm

| | MBEC ASTM | | % Reduction |
|---|---|---|---|
| Materials | E2799-12 Method | Log | Compared to |
| in water | (% v/v) | Reduction | Control |
| DBP | 0.5 | 5.5 | 99.999% |
| DBPT | 0.5 | 5.5 | 99.999% |
| SDBS | >0.5 | — | — |
| SEHS | >0.5 | — | — |
| DBSA | >0.5 | — | — |

SDBS and DBSA removed existing 48-hour biofilm up to 95% and 99%, respectively (Table 9).

TABLE 9
Values of biofilm efficacy for A1026 and A1033 against
C. marina ATCC 25374 48-hour biofilm.

Activity against
C. marina ATCC 25374
48-hour biofilm
ASTM E2799-12 Method

| | | % Biofilm | |
|---|---|---|---|
| Materials | Concentration | Removal | Log |
| in Water | (% v/v) | Efficacy | Reduction |
| SDBS | 0.0630 | 93.18% | 1.17 |
| | 0.0313 | 95.45% | 1.34 |
| | 0.0156 | 81.82% | 0.74 |
| | 0.0078 | 68.18% | 0.50 |
| DBSA | 0.0630 | 98.27% | 1.76 |
| | 0.0313 | 96.27% | 1.43 |
| | 0.0156 | 86.36% | 0.87 |
| | 0.0078 | 73.64% | 0.58 |

### Example 21. Antifouling Treatments Inhibit the Growth of Algae

The molecules (SDBS, SDS, SEHS, and DBSA) were added to the growth culture medium of algae Heterochlorella luteoviridis cf. (SAG 2203.) Algae was grown in 50 ml tubes at 28° C. for 14 days. Absorbance (optical density) was measured at 750 nm in a spectrophotometer and used to determine concentration to inhibit the growth of algae. Algae growth was inhibited by SDBS, SDS, SEHS, and DBSA at 1% concentration.

### Antibiofilm and Antibacterial Characteristics of Compounds and Compositions to Boost Algae and Yeast Fermentation

### Example 22. Compositions and Compounds Boost Growth Rate of Yeast and Algae

The composition comprises one or more organophosphorous and/or organosulfurous compounds, and/or one or more antimicrobial, antibiofilm agent, antifouling agent, preservative, pH adjuster, and solvent.

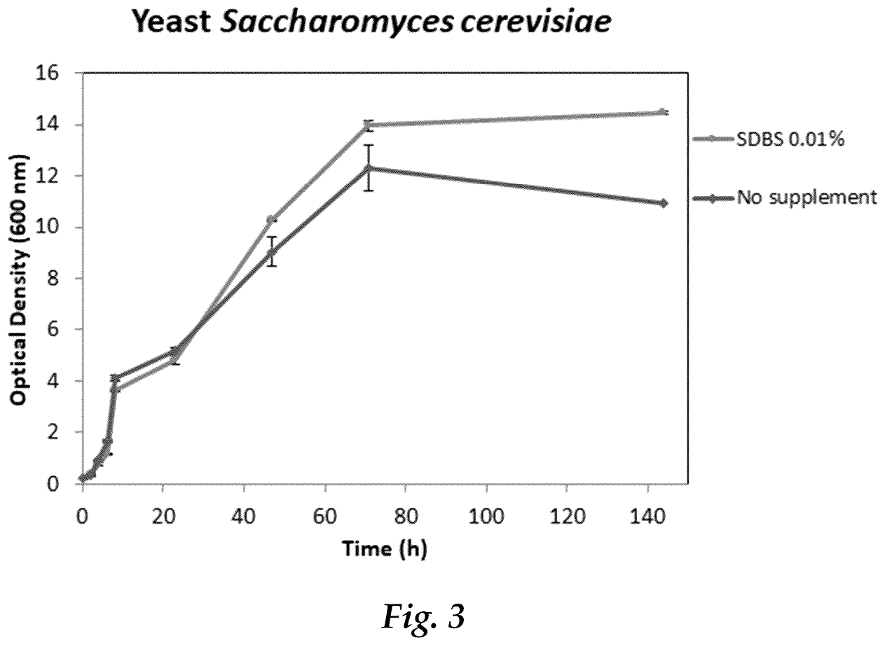

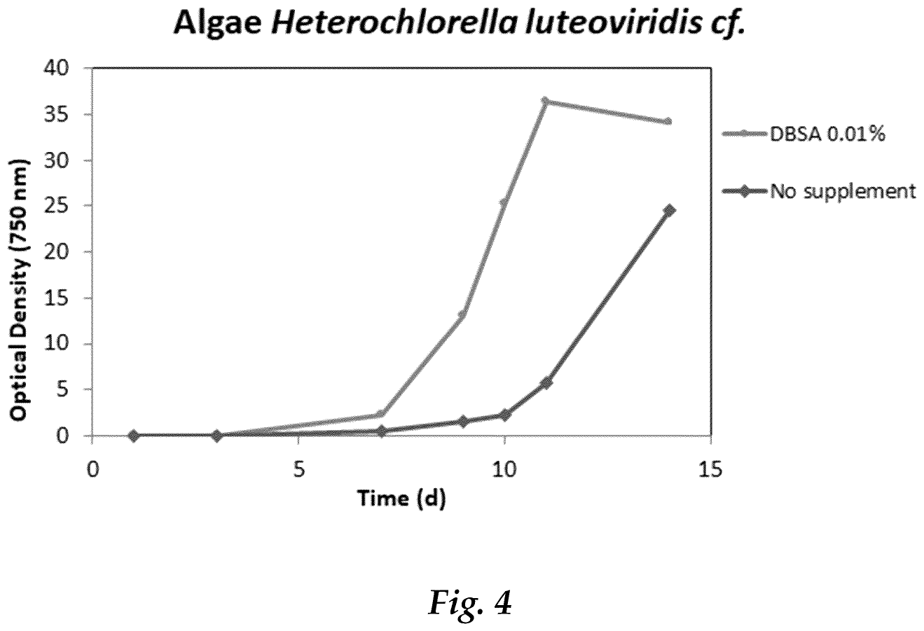

The molecules (SDBS, SDS, SEHS, and DBSA) were added to the growth culture medium of yeast Saccharomyces cerevisiae (ATCC 201389) and algae Heterochlorella luteoviridis cf. (SAG 2203.) Yeast was grown in 250 ml shake flasks and 48-well flower plates in a biolector at 30° C. for 140 hours. Algae was grown in 50 ml tubes at 28° C. for 14 days. Absorbance (optical density) was measured at 600 nm for yeast and 750 nm for algae in a spectrophotometer and used to determine rate of increase of biomass. The biomass of S. cerevisiae increased 32%, 29%, and 9%, in the presence of SDBS (0.01%) (FIG. 3), SDS (0.01%), and SEHS (0.1%), respectively (Table 10). The biomass of H. lutevoviridis cf. increased 39%, 29%, 19%, and 19%, and in the presence of DBSA (0.01%) (FIG. 4), SDBS (0.001%), SDS (0.01%), SEHS (0.1%), and DBSA (0.01%), respectively (Table 10).

TABLE 10
Increase in biomass (%) of algae and yeast with
antibiofilm molecules in culture media.

% Increase in Biomass
(Treatment Concentration % v/v)

| | Algae | Yeast |
|---|---|---|
| | Heterochlorella | Saccharomyces |
| Molecule | luteoviridis cf. | cerevisiae |
| SDBS | 29.17% (0.001) | 31.96% (0.01) |
| SDS | 18.74% (0.01) | 28.77% (0.01) |
| SEHS | 19.31% (0.1) | 8.68% (0.1) |
| DBSA | 39.45% (0.01) | — |

### Antibacterial Characteristics of Compositions and Compounds to Treat Contaminants of Yeast Fermentation

### Example 23. Antibacterial Activity of Treatment Against Common Yeast Fermentation Contaminants

The composition comprises one or more organophosphorous and/or organosulfurous compounds, and/or one or more antimicrobial, antibiofilm agent, antifouling agent, preservative, pH adjuster, and solvent.

The MIC broth microdilution method was used to determine the minimum concentration needed to inhibit the growth of a common yeast fermentation contaminants: L. fermentum and L. delbrueckii. For the MIC test SDBS and DBSA were tested at concentrations (% v/v): 0.4800, 0.2400, 0.1200, 0.0600, 0.0300, 0.0150, and 0.0075.

A1026 (MIC, 0.0075%), A1030 (MIC, 0.0150%), and A1033 (MIC, 0.0150%), inhibited growth of marine biofilm former L. fermentum (Table 11). A1026 (MIC, 0.0150%), A1032 (MIC, 0.0300%), and A1033 (MIC, 0.0150%), inhibited growth of marine biofilm former L. delbrueckii (Table 11).

TABLE 11
Values of antibacterial activity against L. fermentum
(ATCC 9338) and L. delbrueckii (ATCC 9649).

Minimum Inhibitory
Concentration (MIC)

| | |
|---|---|
| (% v/v) | M07-09 |

Method

| Sample | L. fermentum | L. delbrueckii |
|---|---|---|
| A1026 | 0.0075 | 150 |
| A1030 | 0.0150 | 300 |
| A1033 | 0.0150 | 150 |

1. A composition comprising one or more organophosphorous and/or organosulfurous compounds, salts thereof, solvates thereof, or derivatives thereof, in an effective amount to clean a surface, to prevent formation of biofilm, to prevent fouling, to kill microbes, and/or to inhibit the growth of microbes, wherein the organophosphorous and/or organosulfurous compound has the structure of Formula I, Formula II, or Formula III, and wherein
(a) Formula I is 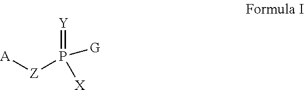
wherein,
A is H, C₁₋₁₆ hydrocarbyl or optionally R¹ substituted C₁₋₁₆ hydrocarbyl; Z is O or a bond; Y is O; G is OH, H, C₁₋₆—COO-alkyl, —O—C₁₋₁₆ alkyl, R¹ substituted C₁₋₁₀ hydrocarbyl, CH₂NHCH₂COOH, or O-aryl; X is H, CN, —NHR, —NHOR, —NHOCOR, R¹ substituted C₁₋₁₀ hydrocarbyl or —OR; and R is H, C₁₋₁₀ hydrocarbyl, or optionally R¹ substituted C₁₋₁₀ hydrocarbyl;
R¹ is selected from halogen, cyano, OH, C₁₋₆ hydrocarbyl, C₁₋₆ alkoxy, SOR², SO₂R², SO₂NR³R⁴, CONR³R⁴, NR³R⁴, NR³COR⁴, NR³SO₂R⁴, NR³CO₂R⁴, NR³CONR⁴, and phosphonic acid, wherein each of C₁₋₆ hydrocarbyl, C₁₋₆ alkoxy, SOR², SO₂R², SO₂NR³R⁴, CONR³R⁴, NR³R⁴, NR³COR⁴, NR³SO₂R⁴, NR³CO₂R⁴, NR³CONR⁴, can be optionally substituted with halo, amino, hydroxyl, C₁₋₆ hydrocarbyl, C₁₋₆ alkoxy, cyano, or phosphonic acid; and
R², R³ and R⁴ are independently selected from hydrogen, C₁₋₆ hydrocarbyl, in which each of the C₁₋₆ hydrocarbyl can be optionally substituted with halo, amino, hydroxyl, C₁₋₆ alkoxy, cyano, or phosphonic acid;
(b) Formula II is 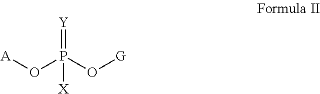
wherein,
A is R, Y is O or S, X is NH2, OH, or OR, and G is R, where R is C₁₋₁₆ hydrocarbyl;
R¹ is selected from halogen, cyano, OH, C₁₋₆ hydrocarbyl, C₁₋₆ alkoxy, SOR², SO₂R², SO₂NR³R⁴, CONR³R⁴, NR³R⁴, NR³COR⁴, NR³SO₂R⁴, NR³CO₂R⁴, NR³CONR⁴, and phosphonic acid, wherein each of C₁₋₆ hydrocarbyl, C₁₋₆ alkoxy, SOR², SO₂R², SO₂NR³R⁴, CONR³R⁴, NR³R⁴, NR³COR⁴, NR³SO₂R⁴, NR³CO₂R⁴, NR³CONR⁴, can be optionally substituted with halo, amino, hydroxyl, C₁₋₆ hydrocarbyl, C₁₋₆ alkoxy, cyano, or phosphonic acid; and
R², R³ and R⁴ are independently selected from hydrogen, C₁₋₆ hydrocarbyl, in which each of the C₁₋₆ hydrocarbyl can be optionally substituted with halo, amino, hydroxyl, C₁₋₆ alkoxy, cyano, or phosphonic acid; or
(c) Formula III: 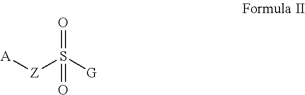
wherein,
A is H, C₁₋₂₀ hydrocarbyl, alkylaryl, or optionally R¹ substituted C₁₋₂₀ hydrocarbyl; Z is O or a bond; G is OH, H, C₁₋₆—COO-alkyl, —O—C₁₋₆ alkyl, R¹ substituted C₁₋₁₀ hydrocarbyl, CH₂NHCH₂COOH, or O-aryl;
R¹ is selected from halogen, cyano, OH, C₁₋₆ hydrocarbyl, C₁₋₆ alkoxy, SOR², SO₂R², SONR³R⁴, CONR³R⁴, NR³R⁴, NR³COR4, NR³SOR⁴, NR³COR⁴, NR³CONR⁴, and phosphonic acid, wherein each of C₁₋₆ hydrocarbyl, C₁₋₆ alkoxy, SOR², SO₂R², SO₂NR³R⁴, CONR³R⁴, NR³R⁴, NR³COR⁴, NR³SO₂R⁴, NR³CO₂R⁴, NR³CONR⁴, can be optionally substituted with halo, amino, hydroxyl, C₁₋₆ hydrocarbyl, C₁₋₆ alkoxy, cyano, or phosphonic acid; and
R², R³ and R⁴ are independently selected from hydrogen, C₁₋₆ hydrocarbyl, in which each of the C₁₋₆ hydrocarbyl can be optionally substituted with halo, amino, hydroxyl, C₁₋₆ alkoxy, cyano, or phosphonic acid.

2. The composition of claim 1, wherein the composition further comprises:
one or more surfactants;
one or more solvents;
one or more antimicrobial agents;
one or more antifoaming agents;
one or more preservatives;
one or more pH adjusters; and/or
one or more agents providing scent.

3. The composition of claim 2, wherein an amount of a component in the composition relative to the total weight of the composition is:
one or more organophosphorous or organsulfurous compounds: 0.00001 wt % to 1.0 wt %,
one or more antimicrobial agents: 0.000001 wt % to 5 wt %,
one or more antifoaming agents: 0.001 wt % to 1 wt %,
one or more surfactants: 0.001 wt % to 30 wt %,
one or more preservatives: 0.00001 wt % to 0.5 wt %,
one or more pH adjusters: 0 to 2 wt %,
one or more agents providing scent: 0.001 wt % to 5 wt %, and/or
one or more solvents: quality sufficient (Q.S.) to 100% solution.

4. The composition of claim 1, wherein the composition is a cleaning agent, an antibiofilm agent, an antifouling agent, and/or an antimicrobial agent.

5. The composition of claim 1, wherein the antimicrobial agent comprises an antifungal agent, an antiviral agent, an antibacterial agent, an antiprotozoal agent, or a combination thereof.

6. The composition of claim 1, wherein the composition further comprises a growth culture medium.

7. The composition of claim 6, wherein the growth culture medium is for culturing yeast and/or algae.

8. A method of cleaning a surface or preventing growth of microorganisms on a surface, wherein the method comprises applying the composition of claim 1 to the surface to clean the surface.

9. The method of claim 8, wherein the surface is an inert surface, an organic surface, or a nano surface.

10. The method of claim 8, wherein the surface is of:
a medical device, and optionally wherein the medical device is an indwelling medical device;
an organism, and optionally wherein the organism is a living or dead organism;
an industrial equipment;
a plant;
an animal, and optionally wherein the surface is of an animal tissue or organ, or
a human tissue, and optionally wherein the surface is a human tissue or organ.

11. The method of claim 8, wherein the composition is an antifouling paint or coating.

12. A method of treating contaminants, wherein the method comprises contacting the contaminants with the composition of claim 1.

13. The method of claim 12, wherein the contaminants are in water, sewage, yeast and algae fermentation broth, or other liquids used in industrial processes.

14. The method of claim 13, wherein the composition is a cosmetic, personal beauty, or hygiene preparation.

15. A method of enhancing growth of yeast or algae, wherein the method comprises adding the composition of claim 1 to a culture containing yeast or algae.

16. The method of claim 15, wherein enhancing the growth of yeast or algae comprises increasing yield of biomass of yeast or algae in the culture as compared to biomass of yeast or algae grown in the absence of the composition.

17. The composition of claim 1, wherein the organophosphorous or organosulfurous compounds comprise sodium dodecylbenzenesulfonate (SDBS), sodium dodecyl sulfate (SDS), 4-Dodecylbenzenesulfonic acid (DBSA), butyl phosphoramidate (BPA), (4-aminophenetyl) dimethylphosphine oxide (APDMPO), dibutyl phosphate (DBP), or dibutyl phosphite (DBPT).

18. A composition comprising one or more organophosphorous and/or organosulfurous compounds, salts thereof, solvates thereof, or derivatives thereof, in an effective amount to enhance the growth of yeast and algae, wherein the organophosphorous and/or organosulfurous compound has the structure of Formula I, Formula II, or Formula III, and wherein
(a) Formula I is 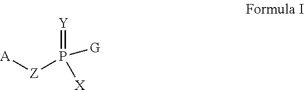
wherein,
A is H, C₁₋₁₆ hydrocarbyl or optionally R¹ substituted C₁₋₁₆ hydrocarbyl; Z is 0 or a bond; Y is O; G is OH, H, C₁₋₆—COO-alkyl, —O—C₁₋₁₆ alkyl, R¹ substituted C₁₋₁₀ hydrocarbyl, CH₂NHCH₂COOH, or O-aryl; X is H, CN, —NHR, —NHOR, —NHOCOR, R¹ substituted C₁₋₁₀ hydrocarbyl or —OR; and R is H, C₁₋₁₀ hydrocarbyl, or optionally R¹ substituted C₁₋₁₀ hydrocarbyl;
R¹ is selected from halogen, cyano, OH, C₁₋₆ hydrocarbyl, C₁₋₆ alkoxy, SOR², SO₂R², SO₂NR³R⁴, CONR³R⁴, NR³R⁴, NR³COR⁴, NR³SO₂R⁴, NR³CO₂R⁴, NR³CONR⁴, and phosphonic acid, wherein each of C₁₋₆ hydrocarbyl, C₁₋₆ alkoxy, SOR², SO₂R², SO₂NR³R⁴, CONR³R⁴, NR³R⁴, NR³COR⁴, NR³SO₂R⁴, NR³CO₂R⁴, NR³CONR⁴, can be optionally substituted with halo, amino, hydroxyl, C₁₋₆ hydrocarbyl, C₁₋₆ alkoxy, cyano, or phosphonic acid; and
R², R³ and R⁴ are independently selected from hydrogen, C₁₋₆ hydrocarbyl, in which each of the C₁₋₆ hydrocarbyl can be optionally substituted with halo, amino, hydroxyl, C₁₋₆ alkoxy, cyano, or phosphonic acid;
(b) Formula II is 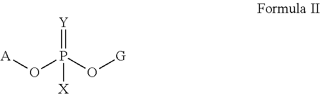
wherein,
A is R, Y is O or S, X is NH2, OH, or OR, and G is R, where R is C₁₋₁₆ hydrocarbyl;
R¹ is selected from halogen, cyano, OH, C₁₋₆ hydrocarbyl, C₁₋₆ alkoxy, SOR², SO₂R², SO₂NR³R⁴, CONR³R⁴, NR³R⁴, NR³COR⁴, NR³SO₂R⁴, NR³CO₂R⁴, NR³CONR⁴, and phosphonic acid, wherein each of C₁₋₆ hydrocarbyl, C₁₋₆ alkoxy, SOR², SO₂R², SO₂NR³R⁴, CONR³R⁴, NR³R⁴, NR³COR⁴, NR³SO₂R⁴, NR³CO₂R⁴, NR³CONR⁴, can be optionally substituted with halo, amino, hydroxyl, C₁₋₆ hydrocarbyl, C₁₋₆ alkoxy, cyano, or phosphonic acid; and
R², R³ and R⁴ are independently selected from hydrogen, C₁₋₆ hydrocarbyl, in which each of the C₁₋₆ hydrocarbyl can be optionally substituted with halo, amino, hydroxyl, C₁₋₆ alkoxy, cyano, or phosphonic acid; or
(c) Formula III: 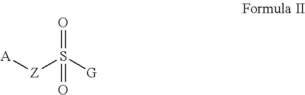
wherein,
A is H, C₁₋₂₀ hydrocarbyl, alkylaryl, or optionally R¹ substituted C₁₋₂₀ hydrocarbyl; Z is O or a bond; G is OH, H, C₁₋₆—COO-alkyl, —O—C₁₋₆ alkyl, R¹ substituted C₁₋₁₀ hydrocarbyl, CH₂NHCH₂COOH, or O-aryl;
R¹ is selected from halogen, cyano, OH, C₁₋₆ hydrocarbyl, C₁₋₆ alkoxy, SOR², SO₂R², SONR³R⁴, CONR³R⁴, NR³R⁴, NR³COR4, NR³SOR⁴, NR³COR⁴, NR³CONR⁴, and phosphonic acid, wherein each of C₁₋₆ hydrocarbyl, C₁₋₆ alkoxy, SOR², SO₂R², SO₂NR³R⁴, CONR³R⁴, NR³R⁴, NR³COR⁴, NR³SO₂R⁴, NR³CO₂R⁴, NR³CONR⁴, can be optionally substituted with halo, amino, hydroxyl, C₁₋₆ hydrocarbyl, C₁₋₆ alkoxy, cyano, or phosphonic acid; and
R², R³ and R⁴ are independently selected from hydrogen, C₁₋₆ hydrocarbyl, in which each of the C₁₋₆ hydrocarbyl can be optionally substituted with halo, amino, hydroxyl, C₁₋₆ alkoxy, cyano, or phosphonic acid.
